(19) United States
(12) Patent Application Publication
(10) Pub. No.: US 2002/0116287 A1
(43) Pub. Date: Aug. 22, 2002

(54) Multi-faceted, tier driven electronic commerce facilitator

(76) Inventors: Timothy D. Schubert, Beaverton, OR (US); Clemente G. Garcia, Beaverton, OR (US); Steve Karakas, Portland, OR (US)

Correspondence Address: STOEL RIVES LLP, 900 SW FIFTH AVENUE, SUITE 2600, PORTLAND, OR, 97204, US

(21) Appl. No.: 10/004,421

(22) Filed: Oct. 23, 2001

Related U.S. Application Data
(60) Provisional application No. 60/242,805, filed on Oct. 23, 2000.

(51) Int. Cl. G06F 17/60

(52) U.S. Cl. 705/26

(57) ABSTRACT

Methods and systems for selling goods and services involve the formation of a contractual alliance of distribution associates, promotion of sales of predefined goods offered by the distribution associates via a centralized Web site, and a tier-driven reverse auction process. A tier driven server system is coupled to the centralized Web site to solicit bids from the distribution associates in response to customer purchase requests made by customers using the centralized Web site. In response to a customer purchase request, distribution associates are selected from the database based on geographic proximity to the customer and availability at the distribution associate of a category of products or services requested for purchase. Information is then sent to the customer identifying the selected distribution associate, thereby including the distribution associate in sales arranged via the Internet without each distribution associate having to build and maintain a presence on the Internet.

### RELATED APPLICATIONS

This application claims priority from U.S. Provisional Patent Application Ser. No. 60/242,805, filed Oct. 23, 2000.

### TECHNICAL FIELD

The present invention is in the field of electronic commerce and, more specifically, pertains to methods and systems for arranging and conducting on-line sales transactions in a manner that is focused on and operates with respect to the actual geographic locations of both buyers and sellers.

### BACKGROUND OF THE INVENTION

E-commerce (electronic commerce), i.e., commerce conducted via communications that involve one or more computers, is exploding. While estimates vary widely, business-to-business (“B2B”) e-commerce plainly accounts for many millions of dollars in trade. Business-to-consumer (“B2C”) commerce is already well established and growing rapidly as well. B2C on-line stores such as Amazon.com have become very well known. B2C portals and vendor sites on the World Wide Web (the “Web”) are growing dramatically in numbers and dollar volume of sales.

Entry into these markets requires a business to buy or build a high-quality Web site, and then make sure the site is robust, up to date, and reliable. It must be available or “on-line” at all times (sometimes called “24×7” alluding to 24 hours a day, seven days a week). The Web site must also be e-commerce enabled, providing for secure processing of orders and payment transactions. It must also address customer privacy protection; an area the Federal Trade Commission is now beginning to address. All of these requirements are challenging and relatively expensive for a small business. A local, single-store retailer of goods or services in most cases cannot afford the necessary technology. Nor can the small retailer afford the kinds of advertising budgets that large chains or “superstores” spend to draw customers (“eye-balls” or “traffic” or “hits” in the vernacular) to their Web sites. The Internet, although egalitarian in theory, is instead becoming dominated by very large corporations with enough capital to influence the popular search engines so that they steer most customers to those corporations. What is needed is a way to allow the small, local retailer to participate—and compete effectively—in the 21st century e-commerce marketplace.

Another challenge facing small business is that of maintaining an adequate and appropriate inventory of products. There is of course a cost associated with almost any inventory, and the larger the inventory the higher the cost. A large chain or superstore can maintain a huge inventory because the cost is spread over high volume and the operation is more efficient than the small, single-store location. But to compete in e-commerce, any merchant must have a reasonably broad product offering available “on-line” and stand ready to ship the product within a day or two. There remains a need to enable a small business merchant to maintain a large inventory and be able to ship product in a timely manner.

The retail merchant must be able to compete on price as well. E-commerce consumers are very price sensitive. There are sites on the Web that provide price comparison data acquired by searching other sites. Consumers have many options and especially with respect to fungible or standard products they have little motivation not to buy at the lowest price. Large businesses, be they pure Internet players like Amazon.com or “click-and-mortar” merchants like Eddie Bauer or Sears all potentially enjoy the benefits of volume purchasing and thus can be very price competitive. The need remains to enable a small business to better compete on price in the e-commerce marketplace.

What distinguishes many local businesses from the “big guys” is just that—they are local—and have a store in the customer's neighborhood or a short drive or bus ride away. The customer can visit in person to see the merchandise and get advice. Often the merchant is personally acquainted with many of her customers. These local customers feel some loyalty to the local merchant, yet they are drawn to the Web by advertising, price and convenience. It would be beneficial to local merchants to preserve their local clientele without requiring loyal customers to abandon the benefits of e-commerce.

It is known in e-commerce to identify merchants in the same locale as the Internet customer. For example, the Yahoo portal can provide a list of merchants for a given product or service line within a postal zip code or city specified by the user. Yahoo lists the approximate distance to the merchant from the reference location. It is also known to provide maps and “turn-by-turn” driving instructions to help a user go to a listed merchant. And of course, for those merchants who have their own Web sites, a user can “click” to that site from a portal, search engine, directory or the like. These features enable a user to find a local merchant if they wish, but they do nothing to motivate or encourage the user to patronize the local merchant. The now famous eBay consumer auction Internet site also provides a “regional” option for users who choose to trade or limit their searching within a fixed region such as a selected state or the Midwest.

In a “reverse auction,” multiple sellers offer goods or services for sale, and the sellers may “bid” down the asking price until they find a buyer. This is often done with excess inventory in the B2B space. In another model, a customer specifies a desired product or service and optionally the price the customer is willing to pay. The first vendor indicating its willingness to sell at the specified price can close the deal, or the buyer can purchase from the vendor offering the lowest price (in a timely manner and duly responsive to the original request). In the latter case, the customer may be soliciting an “e-RFQ.” In any event, a “reverse auction” is characterized by multiple vendors potentially responding to a single customer's request, as distinguished from the conventional auction in which multiple potential customers may respond to a single seller's offer to sell. The Internet is an effective medium for reverse auctions and makes these processes relatively fast and convenient. In general, however, Internet reverse auctions are focused on price and do not take geography or locality into account. Nor do they do anything that would specifically support a small, local merchant's efforts to participate. The need remains to empower the small business to profitably participate in the various forms of e-commerce.

### SUMMARY OF THE INVENTION

A primary aspect of the present invention comprises a method for facilitating commerce that leverages the communication power of the Internet so as to benefit relatively small, local retailers of all types of goods and services. This method can be described as a “tier-driven, reverse auction” as follows. First, a group of interested retailers are enlisted for participation as affiliated distribution associates or “D/As”. A sponsor or coordinator (SAA) builds a high-quality, high-reliability enterprise Web site where customers go to shop on-line. The enterprise Web site is “centralized” in the logical sense that there is only a single, primary site, at least initially. (The “site” may in fact comprise a distributed architecture for improved performance, reliability and other technical features.) Multiple sites, each dedicated to a particular line of products or services may be developed, but initially a single site can be used, where multiple goods and services are listed, organized into perhaps 30 or 40 fully searchable product categories to facilitate “browsing.” The goods and services listed on the central Web site correspond to those offered by the affiliated D/A's. A relatively modest fee paid by each of the D/A's helps support the cost of developing and maintaining the central site.

Data regarding each of the D/A's is maintained in a database coupled to the enterprise Web site, such data including product categories (or SKU's) selected by the retailer at sign-up as reflecting the goods that retailer chooses to offer. (Throughout the remainder of this specification and the claims, we'll use “goods” generically to include goods and services, except where otherwise specified.) The database also includes a unique identifier for each D/A, instructions for communicating with the D/A and, importantly, the geographic location of the D/A.

A retail customer using the central Web site can identify a product he wishes to purchase, and submit a “purchase request.” The Web site sends back an acknowledgment to the customer indicating that the purchase request has been received. Responsive to the customer's request, a tier-driven server (“TDS”) coupled to the Web site selects those distribution associates, as reflected in the database, who are geographically located proximate to the customer and who previously identified a category that includes the specific product or service requested for purchase. The TDS then sends a bid request message to each of the selected distribution associates, communicating with each of them in the respective manner specified in the database, e.g., by e-mail, voice mail or fax. The message essentially solicits an offer to sell the specific product or service requested for purchase. The TDS then collects response messages or “bids” from the selected distribution associates that respond within a specified time limit, e.g., three hours. Each seller response or bid is responsive to a specified seller request message and includes a price term. The bids can be submitted by various communication means that may be available to the responding D/A, such as return fax, telephone call (to an IVR system), e-mail etc. Participating D/A's need not have a computer, yet the central Web site will expose them to substantial business opportunities on the Web as explained further herein.

The TDS next validates each of the received seller response messages, and determines the lowest price valid bid. Then the TDS sends an offer to sell the specific product or service requested for purchase, at the price indicated in the “winning” bid, to the customer (on behalf of the distribution associate that submitted the lowest price valid bid). If the customer timely indicates acceptance of the offer, the TDS processes the acceptance so as to complete the sale, whereby the customer's purchase request is fulfilled by a distribution associate within the same geographic area as the customer and at a competitive price. Each pending or open transaction is maintained on the TDS, and can be deleted after completion of the transaction or expiration of a predetermined time limit.

If none of the selected D/A's submits a valid bid within the initial time limit, the TDS defines a second tier of D/A's to receive a second round of bid request messages, again to find a seller to fulfill the customer's purchase request. The second-tier D/A's are geographically located somewhat further away from the customer than the first tier, but the second tier is nonetheless defined as centered about the customer's location. Thus the second tier can be viewed as a concentric region or “do-nut shape” region generally surrounding the first tier region (which includes the customer location). Bid requests are sent to the second tier D/A's, responses are collected, and a winning bid is processed as before if one is received. Processing the sale transaction (in any tier) preferably includes collecting a commission or fee for the benefit of the central Web site sponsor.

If none of the selected second-tier D/A's submits a valid bid within a predetermined time limit, the TDS defines yet a third tier of D/A's to receive a third round of bid request messages. The third-tier D/A's are geographically located somewhat further away from the customer than the second-tier D/A's. Bid requests are sent to the third-tier D/A's, responses are collected, and a winning bid is processed as before if one is received. If none of the selected third-tier D/A's submits a valid bid within a predetermined time limit, the TDS defines yet a fourth tier of D/A's to receive bid requests, and so on, until the customer request is satisfied or preset limits are reached. Successive tier regions can be defined as may be necessary, expanding to the customer's city, region, state, country and even globally if necessary. However, this is not to imply that tiers are defined simply along political boundaries. To the contrary, as further explained later, tiers are dynamically defined with respect to distance, driving time, shipping costs, taxes and tariffs, shipping time and other factors generally relating to the convenience of the customer, and based on the customer's location.

A second important aspect of the invention addresses the inventory problem faced by relatively small, local retailers as mentioned above. Even if a retailer customarily deals in a particular product, he may be temporarily out of stock in that item when a bid request is received on that item from the TDS. To promote customer satisfaction, contractual arrangements between the central sponsor and the D/A's should require each D/A to ship the product within a predetermined time, say 24 hours, after the customer indicates acceptance of the D/A's bid. The present invention can be leveraged to help the retailer obtain the required stock from other participating D/A's in a timely manner for resale to the retail customer. According to this aspect of the invention, the TDS described above, or a second TDS system similar to the one described above, unites the D/A's into a wholesale bidding network. If a D/A wants to respond to a purchase request, but does not have the requested item in stock, the D/A can issue a request to other D/A's to purchase the item at the wholesale level. More specifically, the D/A sends a wholesale bid request message to the TDS, which in turn identifies a first tier of D/A's who may have the item, and then sends a corresponding wholesale bid request message to each of them. This process is similar to the customer request process in several ways. The system communicates with the D/A's by whatever means the D/A chooses, for both retail and wholesale level messaging. Time limits and other terms and conditions are agreed upon in advance. D/A's responding to a wholesale bid request again provide a price term, in this case a wholesale bid. The expanding tier process is invoked as necessary, incrementally broadening the wholesale inquiry until the product is found. As a result, even if the local retailer did not have the item in stock initially, he has a process to get it very quickly, at a competitive price, so the sale is not lost. The retail customer still has the benefit of dealing with a local retailer who has now received the product from another dealer.

A third aspect of the invention presents the Web site user with options to “buy local” or use the “Bid Wheel” option. The “Bid Wheel” refers to the tier-driven process described above, alluding to the concentric tier regions forming an image like a wheel. Using the “buy-local” option, the Web site server identifies D/A's geographically close to the customer who have listed the product category, or specific product SKU, requested by the customer. The server provides a picture of the local D/A store, map, driving directions or bus route info and the like to help get the customer to the local neighborhood D/A. It can also link to the D/A's own site but the D/A need not maintain its own Web site to participate in this system. Under the “Bid Wheel” option, the central site provides a tier-driven reverse auction system as described above, defining incrementally expanding tiers to meet the customer's requirement.

A fourth aspect of the present invention is directed to a process for enlisting retailers to participate as D/A's in the system described above, and includes creation of Web presence for the small retailer in “real time” as further explained later.

A fifth aspect of the present invention is the TDS Driven Merchant Mailer, which allows a merchant to mail a special offer to a wide variety of consumers who have opted to receive such special offers.

A sixth aspect of the present invention is the TDS Driven Vertical Market Broadcast, which allows a merchant, through the merchant network that is created by the vertical net directory, to have access to other small business owners that can be queried for sales or purchases.

A seventh aspect of the present invention is the TDS Driven Mobile Tiering system. The mobile tiering system implements the TDS in a wireless context to provide services similar to those described above, but in a situation where the epicenter of the tiers can be moving, thus causing the system to dynamically define the extent and epicenter for the tiers.

The present invention thus addresses the myriad needs of smaller, local retailers so that they can compete with larger businesses on the Internet. The local retailer enjoys the benefits of a high-quality, high-reliability presence on the Internet without the corresponding costs. The retailer can effect retail transactions via the central Web site without incurring the costs of e-commerce transaction processing infrastructure. The retailer maintains a local advantage and relationships with local customers who use the Internet, because local customers will be “connected” to the nearby retailer through the methods and systems described herein. The retailer also has a new mechanism to quickly obtain inventory as necessary to close a sale opportunity.

Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 is a conceptual illustration of a customer-centric, geographically tiered arrangement of retailers herein referred to as Distribution Associates.

FIG. 2 is a conceptual illustration of a customer purchase request sent to a central Web site and communication of corresponding seller requests to DA's located within a local tier region proximate to the customer's geographic location.

FIG. 3 is a conceptual illustration of communicating the corresponding seller requests of FIG. 2 to a second set of DA's within a second tier region.

FIG. 4 is a conceptual illustration of communicating the corresponding seller requests of FIG. 2 to a third set of DA's within a third tier region.

FIG. 5 is a conceptual illustration of a series of geographic tier regions generally concentrically centered about the geographic location of a customer who submits a bid request.

FIG. 6A is a conceptual illustration of a series of geographic tier regions generally concentrically centered about the geographic location of a customer but biased by a shipping zone boundary that affects product shipping costs.

FIG. 6B is a conceptual illustration of a series of geographic tier regions generally radiating from the geographic location of a customer but bounded by a natural obstacle.

FIG. 6C is a simplified map illustrating a series of geographic tier regions generally concentrically centered about the geographic location of a customer, but biased by an interstate highway affecting driving times to various DA locations.

FIG. 7 illustrates the principal components of a database for implementing the present system.

FIG. 8 is a simplified, high-level diagram of the tier-driven server (“TDS”) software.

FIG. 9 is a flow diagram illustrating the TDS logic engine of FIG. 8 in greater detail.

FIG. 10 is a flow diagram illustrating the bid system logic of FIG. 8 in greater detail.

FIGS. 11A, 11B, and 11C are pseudo-code listing descriptions of the TDS logic engine; the TDS bid system; the Quick Response System; and the Create Tier Region logic of FIG. 8.

FIG. 12 is a flow diagram illustrating the Create Tier Region logic of FIG. 8 in greater detail.

FIG. 13 is an example of a Web home page for customer interaction with the tier-driven reverse auction system of the present invention.

FIG. 14 is an example of a Web page for product selection and local versus bidwheel options.

FIG. 15A illustrates a C to B to B to C process in accordance with another aspect of the present invention that enables distribution associates to locate and purchase merchandise at the wholesale level utilizing the Bid Wheel process.

FIG. 15B is a conceptual illustration of a Distribution Associate bid request and communication of corresponding wholesale bid requests to DA's within a local tier region proximate to the originating DA's geographic location.

FIG. 16 depicts a B2B wholesale tunneling TDS product or service search.

FIG. 17 depicts a flow diagram for a TDS vertical net broadcast network.

FIG. 18 depicts a merchant mailer system.

FIGS. 18A-18I depict a series of screen shots, interfaces, dialogs, broadcast messages, and similar items for use in the merchant mailer system of FIG. 18 or the vertical net broadcast of FIG. 17.

FIG. 20 depicts a Tier collapse model.

FIG. 21 depicts a live load process used to include merchants within the TDS.

FIGS. 22A-22D depict various aspects of a wireless or mobile tiering system.

### DETAILED DESCRIPTION OF PREFERRED EMBODIMENTS

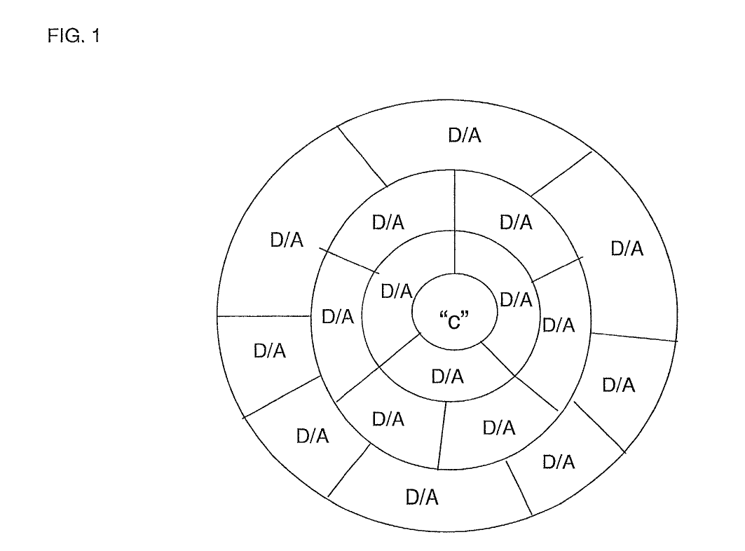

FIG. 1 is a conceptual illustration of geographic tiers in accordance with the present invention. In FIG. 1, the diagram 100 illustrates a commerce space in which the consumer or customer 102 is at the geographic center. A concentric region 104 surrounding the customer 102 represents a first tier region comprising a plurality of distribution associates as further described below. A second concentric tier region 106 surrounds the first tier region 104, to illustrate the concept that each successive tier region is geographically more distant from the Customer 102 located at the center. Additional tier regions can be defined, in a theoretically unlimited number, each successively more distant from the center 102 and surrounding the next preceding adjacent tier region. This figure is merely conceptual—in practice tier regions will rarely be perfectly round.

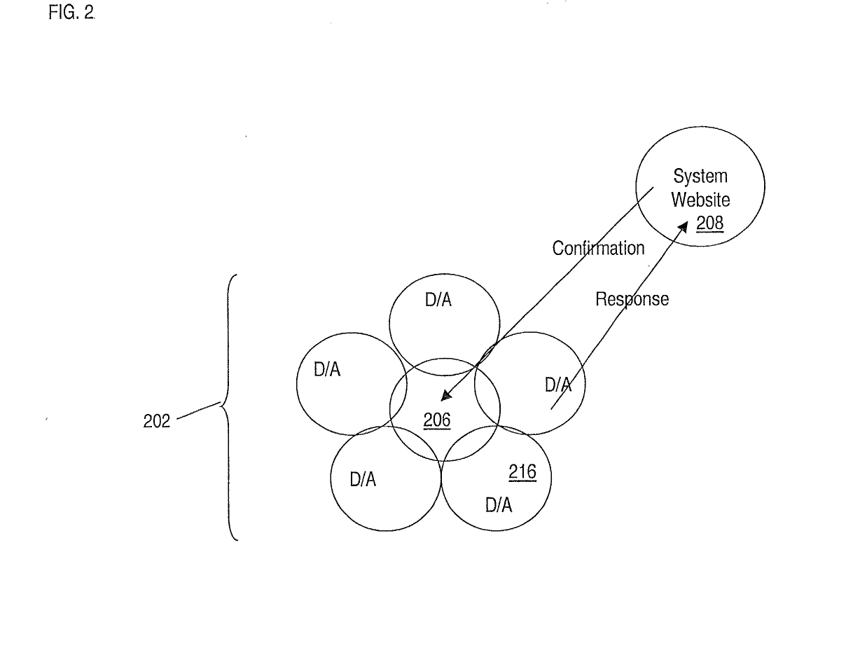

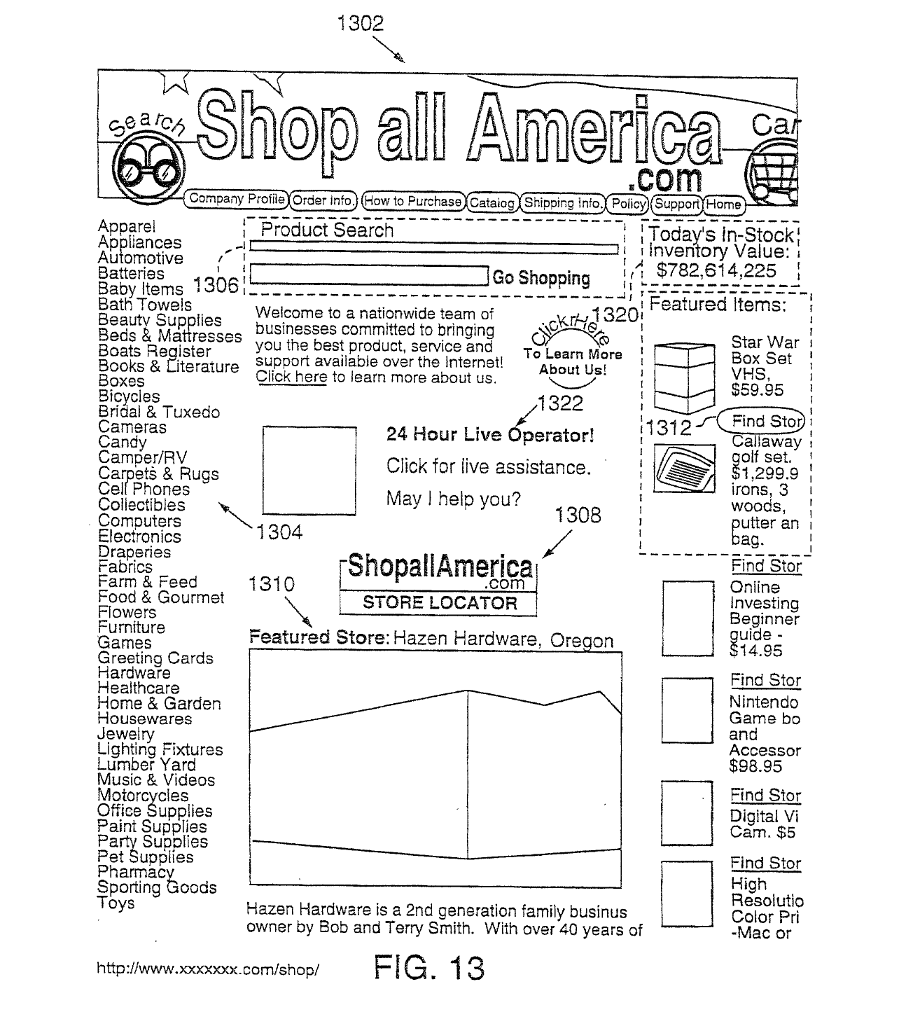

FIG. 2 is a conceptual illustration of a tier-driven reverse auction process according to the invention. In FIG. 2, a customer 206 (corresponding to the customer 102 of FIG. 1) sends a purchase request 210 to an Internet Web site 208. A purchase request message typically includes identification of a specific product or service requested for purchase by the customer. In practice, the customer does not literally prepare and send the message. Rather, a process to do so is implemented in software operable on a Web browser, and the user simply interacts with a graphical user interface of the type illustrated in FIG. 13, largely “clicking” to indicate choices and submit the request. Preferably, the Web site 208 automatically sends an acknowledgment message (not shown) to the customer indicating that the purchase request has been received.

In response to the received purchase request, software located at or in communication with the Web site 208 selects a set of distribution associates, i.e., retail merchants, who may have the requested product or service available for sale. (This software system is referred to and further described later as a “Tier-driven Server” or “TDS.” For now, we assume that the Web site 208 includes the TDS.) The Web site 208 then sends a seller request message or “bid request” to each of the selected distribution associates, for example bid request message 212 is sent to distribution associate (“D/A”) 204. An identical bid request message 214 is transmitted to D/A 216 and so forth. The selected group of distribution associates, also called Bid Community No. 1, is indicated by reference No. 202. This initial bid community 202 which is geographically close to the customer 206 corresponds to the first tier region in the conceptual diagram 100 of FIG. 1.

Each of the distribution associates in the bid community 202 has an opportunity to send a seller response message or “bid” back to the Web site 208 within a predetermined time period, for example two hours. Contractual relationships and arrangements for communications between the Web site 208 and the various distribution associates is predetermined as will be described below. Each bid, from those D/A's who choose to bid, includes an indication of the price at which the responding D/A is willing to sell the specific product or service requested by the customer. Preferably, the bid is below the manufacturer's suggested retail price of the item. The lowest price valid bid will be used as an offer to complete the transaction requested by the customer as explained in more detail later.

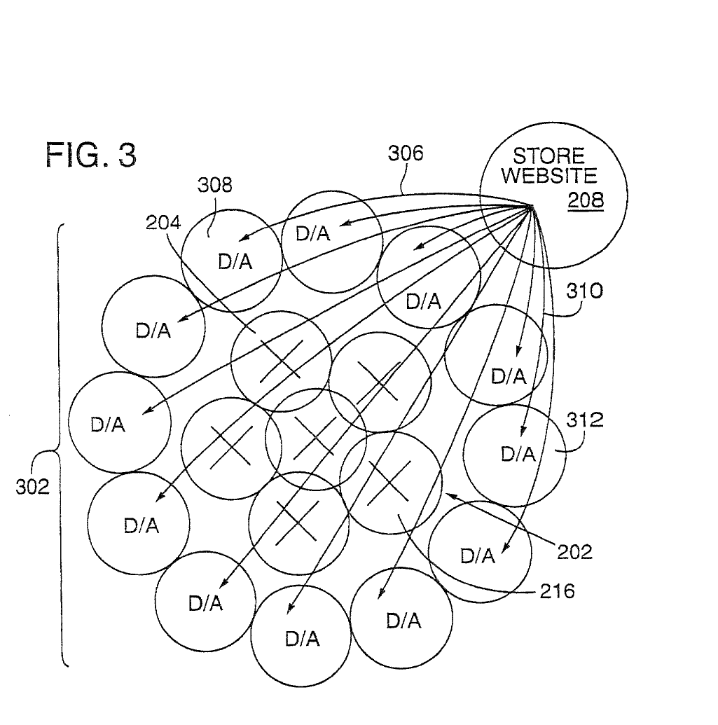

In the event that no valid bid is received within the allotted time from any member of the first bid community 202, the Web site 208 (TDS) defines a second, larger tier region illustrated as bid community 302 in FIG. 3. Referring now to FIG. 3, the Web site 208 sends a bid request message 306 to a D/A 308 located in the second tier region 302. The same bid request message 310 is sent to D/A 312, and so on to all members of the second bid community 302. Recall that the bid community generally does not include all distribution associates within a given region. Rather, the bid community is defined dynamically to select only those distribution associates who are located within a specific area (centered around the customer's location) and that have indicated (during “sign-up”) that they generally carry the product requested by the customer. This second bid community 302 corresponds to the second tier region 106 in the conceptual diagram 100 of FIG. 1.

Thus if the D/A's located in the first tier region closest to the customer cannot satisfy the customer's request, a similar bid request is automatically distributed to this second tier region which spans a larger geographic area and usually includes a greater number of D/A's. For example, a first tier region might be selected that includes six D/A's whereas the second tier region might include a dozen retailers, although these numbers merely represent initial values. The TDS software can be designed to gather statistical information about operation of the system over time, and it can use that information to optimize how it defines tier regions, including the numbers of qualified D/A's in a region, the allowed response times, etc. The goal would be to send the bid request to a sufficient number of D/A's to solicit a satisfactory response within a reasonable time.

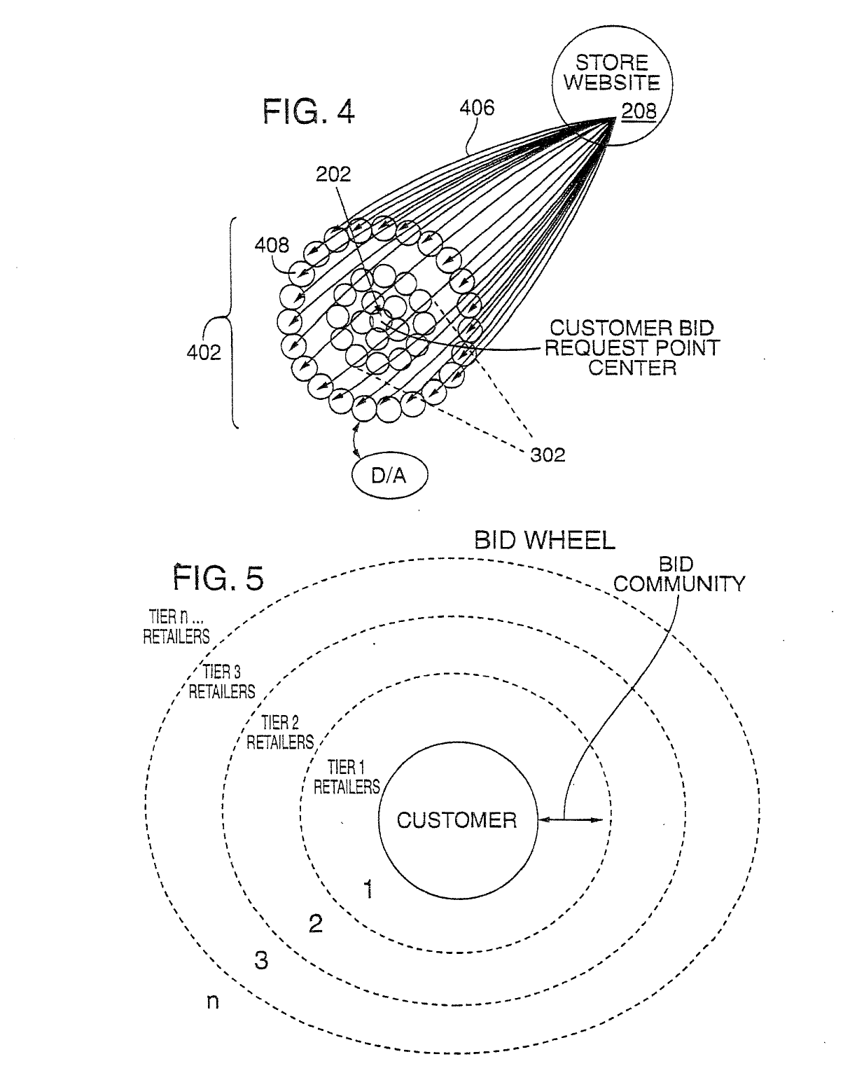

FIG. 4 illustrates the process that occurs in the event that no D/A in the second bid community 302 submits a valid response or bid within the amount of time. In that case, the Web site system 208 defines a third tier region and identifies a group of distribution associates in the third geographic region that may wish to provide the specific product or service requested by the customer 202. This third tier region 402 is illustrated in FIG. 4. Again, all of the D/A's in the current tier region are sent the same bid request message, e.g., message 406 sent to D/A 408. Additional tier regions can be defined in similar fashion as may be necessary. In this way, the community of distribution associates receiving bid requests is automatically expanded until the customer's request is satisfied (or predetermined limits on time, geography, etc. are reached). FIG. 5 is another conceptual diagram illustrating this “Bid Wheel” process in which tiers of retailers are identified first in the geographic area proximate to the customer and then in successively larger tier regions expanding generally concentrically about the customer's location.

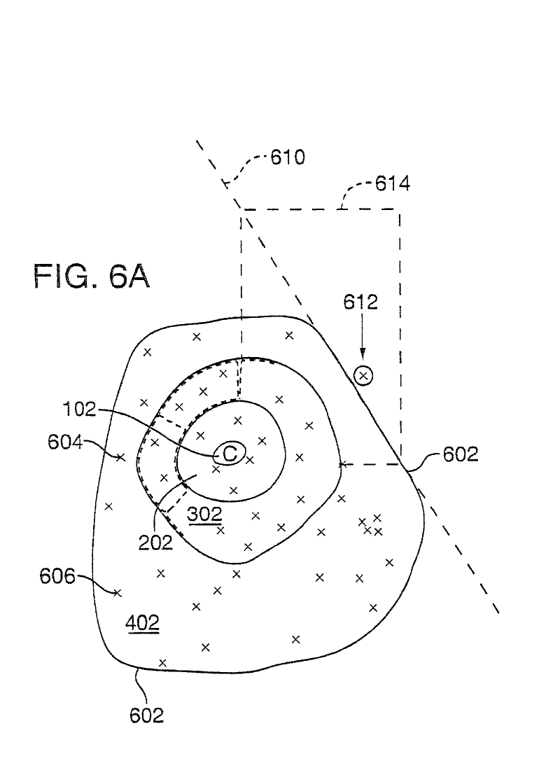

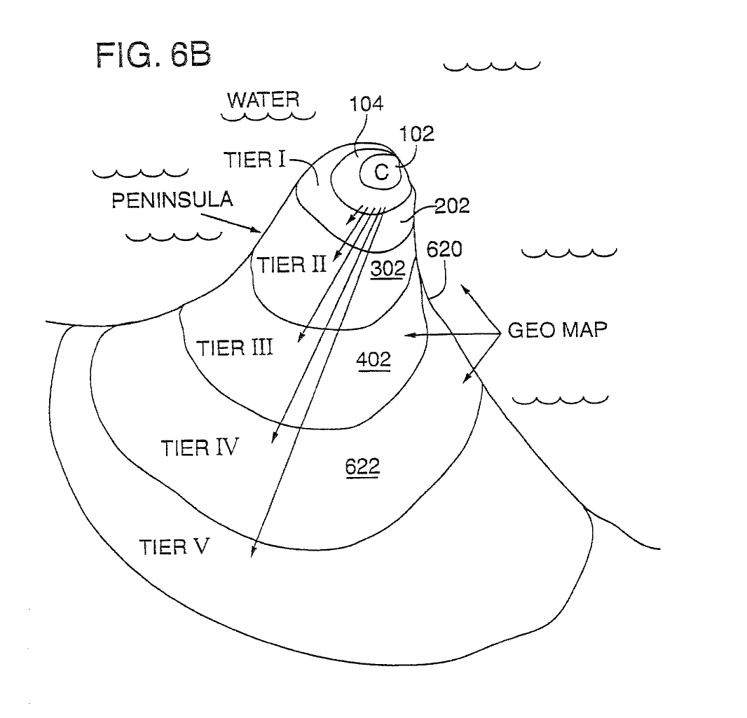

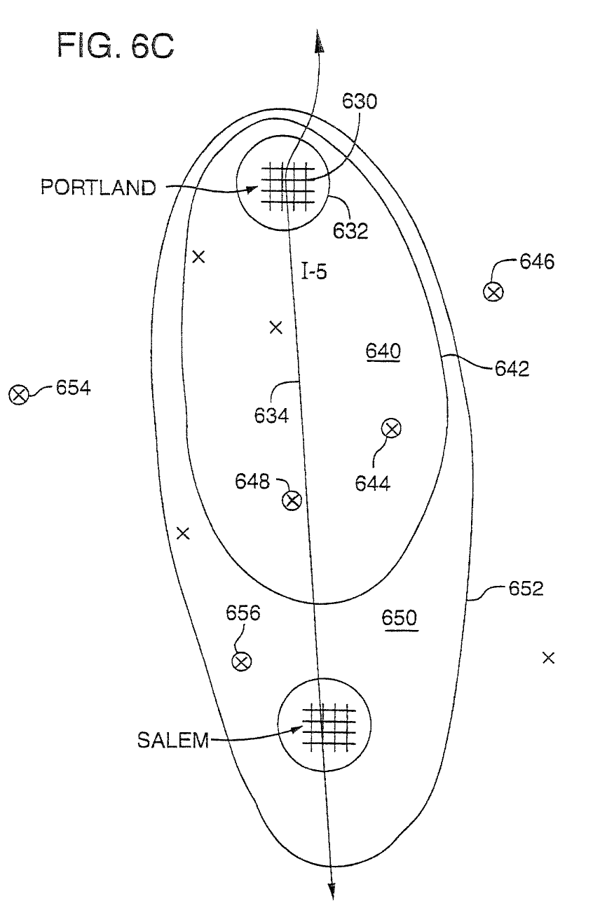

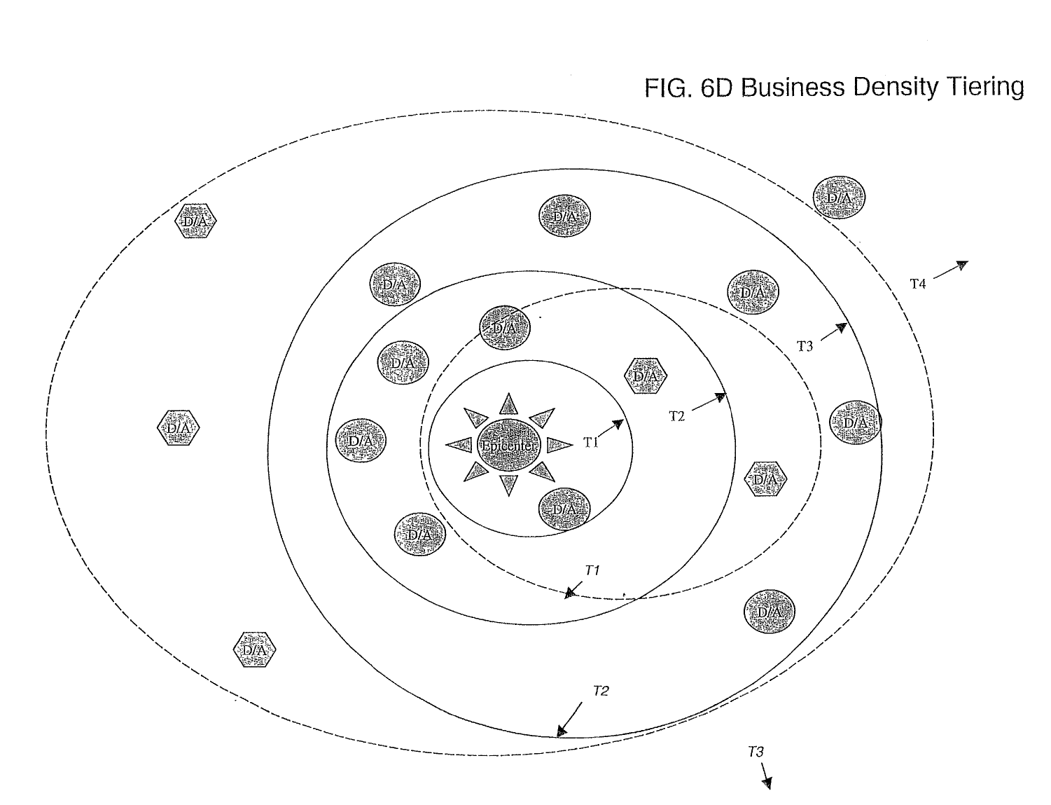

The concept of “proximity” of a retailer to a customer is not based solely on distance “as the crow flies”. Other factors preferably are taken into account in fashioning tier regions. Referring now to FIG. 6A, several tier regions are shown generally surrounding a customer location 102. In this drawing, D/A locations are shown by small x's such as the D/A location 604. The first tier region 202 is shown generally surrounding the customer 102 as described before. A second tier 302 is generally concentrically arranged around the first tier 202. FIG. 6A also indicates the location of a shipping zone boundary 610 which may be defined, for example, by a freight carrier in connection with assessing freight charges. In the figure, a third tier region 402 which is circumscribed by a border 602 might have crossed over the shipping zone boundaries 610. Instead, the third tier region is truncated so that it is entirely within a single shipping zone boundary. Consequently, a D/A such as D/A 612, which may in fact be geographically closer to the customer 102 than another D/A, say 604, is excluded from the third tier 402 because of the shipping zone boundary. This strategy will give preference to other distribution associates in the third tier in order to fulfill the customer's request without crossing the shipping zone boundary if possible. FIG. 6A also illustrates a postal zip code boundary 614. In many cases, zip codes conveniently can be used for defining tier regions. Here, however, the shipping zone boundary 602 took precedence over the zip code boundary, as well as actual distance, in defining tier region 402.

In FIG. 6B, a customer 102 is located near the tip of a peninsula 620 that extends into a lake or other body of water. In this case, the tier regions 202, 302, 402, 622, etc. are limited by the water and consequently they assume a somewhat parallel arrangement rather than concentric circles. In some cases a body of water would not impose constraints on a tier region definition, for example where a distribution associate bids to download digital content from a satellite. (Licensing digital rights is within the broad concept of sales of goods or services as described herein.)

FIG. 6C illustrates another example of a series of tier regions, in this case defined predominantly by motor vehicle travel time rather than distance. In this example, the customer is located in a city (Portland) 630 which lies on an interstate highway 634. A second city, Salem, is shown some distance away from Portland and also situated along the interstate. Here, a first tier region is shown circumscribed by boundary 632 generally surrounding the Portland city limits. A second tier region 640 surrounds the first tier region but, as indicated by its boundary line 642, it is elongated so as to extend largely along the interstate highway. Consequently, a distribution associate such as D/A 648 falls within the second tier region 640, while another D/A such as D/A 646, even though it may be closer to the customer “as the crow flies,” is outside the definition of the second tier region (and even the third tier region) because of its distance from the highway. In other words, the driving time to D/A 648 from Portland is shorter than the driving time to the apparently closer D/A 646. A third tier region 650 is illustrated, circumscribed by border 652, extending further along the I-5 corridor and including the City of Salem. Another distribution associate 654 is closer to the Portland customer than Salem, but it is excluded from tier region 650 because of its distance from the highway, resulting in longer driving time. In addition to the geographical tier determination based on factors such as natural obstacles, drive time, distance from the epicenter, etc., economic tiering can also be implemented into play. At its simplest, economic tiering can be based on business density as in FIG. 6D. With reference to the D/A representation in FIG. 6D, it is obvious that the tiers have been defined on the distribution of the businesses. The area around the epicenter has four tiers for the oval D/A's while only three tiers have been defined for the hexagonal D/A's. While the relationship of FIG. 6D shows all of the D/A's to be geographically grouped, this is not necessarily the case. For a more common business, for example a restaurant or hair salon, the tiers might have tier radius of one-half mile for tier 1, one mile for tier 2, two miles for tier 3, five miles for tier 4, etc. However, for another set of D/A's, for example car dealers, tier 1 might be five miles, tier 2 ten miles, tier 3 twenty miles, etc. Distribution of the D/A's density is used to create a “critical mass” bid pool. The main components of economic tiering are business density and population, but components such as NAISC codes, sales taxes, business inventories, etc. can be used to assist in the definition of an economic tier. While the examples shown here are circular in design, the tier divisions do not have to be based on radius from the epicenter. Economic tiering, like geographical tiering, can follow streets, rivers, or political boundaries such as county, parish, state, or country boundaries, or the like. The reader will appreciate from these examples that the process of defining tier regions with respect to any given customer location preferably takes into account topography, shipping methods and costs, streets and highways (driving time), and other factors that would affect customer convenience or costs.

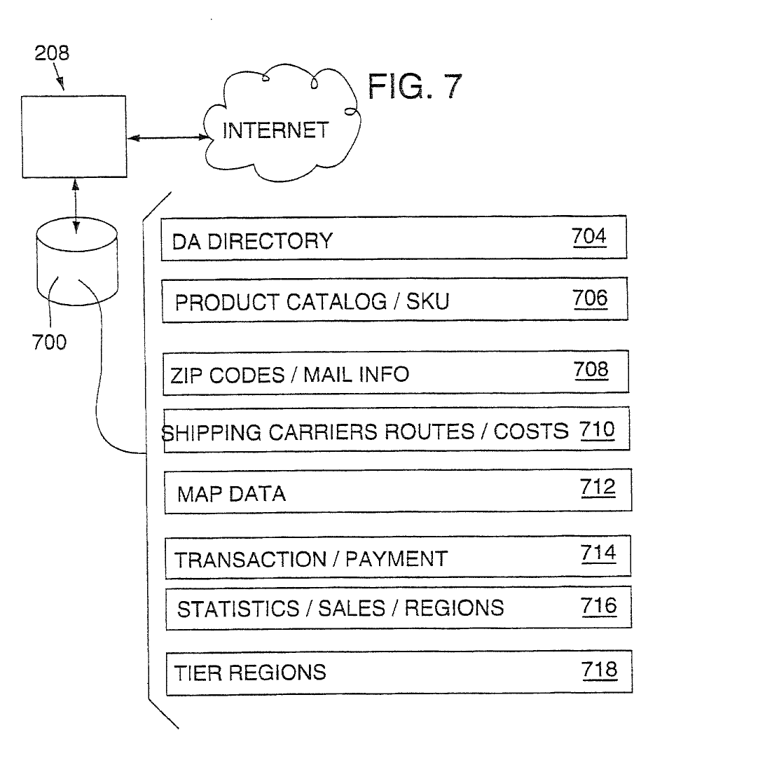

FIG. 7 illustrates the shopping Web site 208 which is connected to the Internet for communications with customers as mentioned above. Web site 208 includes or is coupled to suitable hardware and software that implements a tier-driven server (“TDS”). The TDS is coupled to a database 700 which provides information essential to operation of the TDS, including the following: A D/A directory 704 contains information about all of the distribution associates that are a part of this enterprise, including identifying information, location of the D/A, product and service categories offered by the D/A, and information for communication with the D/A (via telephone, fax, Internet, e-mail, etc.), which we call a “communication key”. Database 700 further includes a product catalog 706 specifying the products and services offered for sale at the enterprise site 208, preferably including SKU (stock keeping unit) numbers and msrp pricing. The catalog also can include detailed descriptions of the goods and services, digital photographs, audio, video etc. as is known in the context of conventional shopping Web sites.

Another aspect of the database 700 comprises zip code information and USPS mailing costs 708. Another component 710 of the database 700 includes shipping information for various carriers and routes, definitions of shipping zones and charges and the like. A further component of the database is map data 712 which can include a variety of information such as streets and highway locations, population, topography, natural features, etc. which may be pertinent to dynamically defining tier regions. A wide variety of suitable digital map databases are commercially available.

A further component of the database 700 stores transaction data 714, i.e., records of the purchase transactions effected via the Web site 208, as well as payment information related to those transactions. This transaction data can also include customer data, with or without personal identifying information. It can be used to track rewards, discounts and similar incentives (“NetStamps”) to encourage repeat business. Another component 716 of the database 700 can be arranged for collecting and analyzing statistical information about the Web site activity, including sales data. Still another component of the database includes tier region data 718, although tier regions will be created dynamically on an ongoing basis. Nonetheless, tier region experience can be accumulated and “mined” for ongoing optimization of the present system.

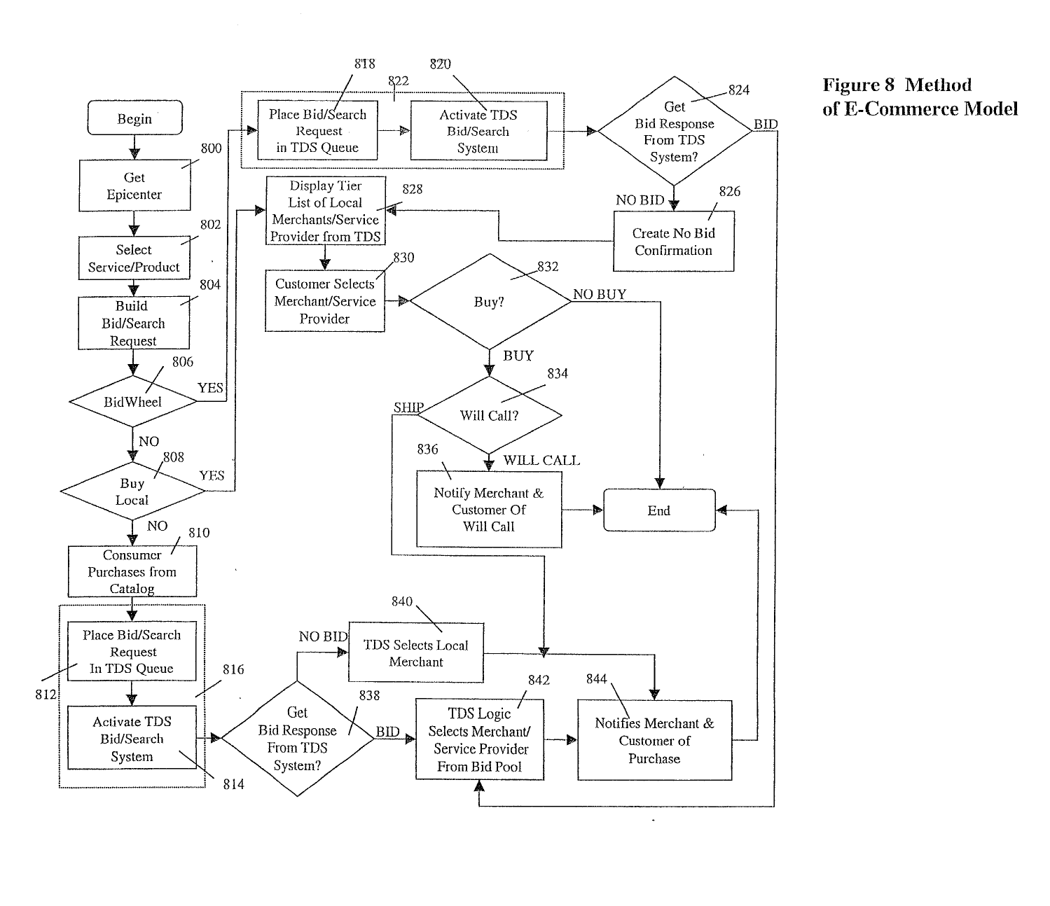

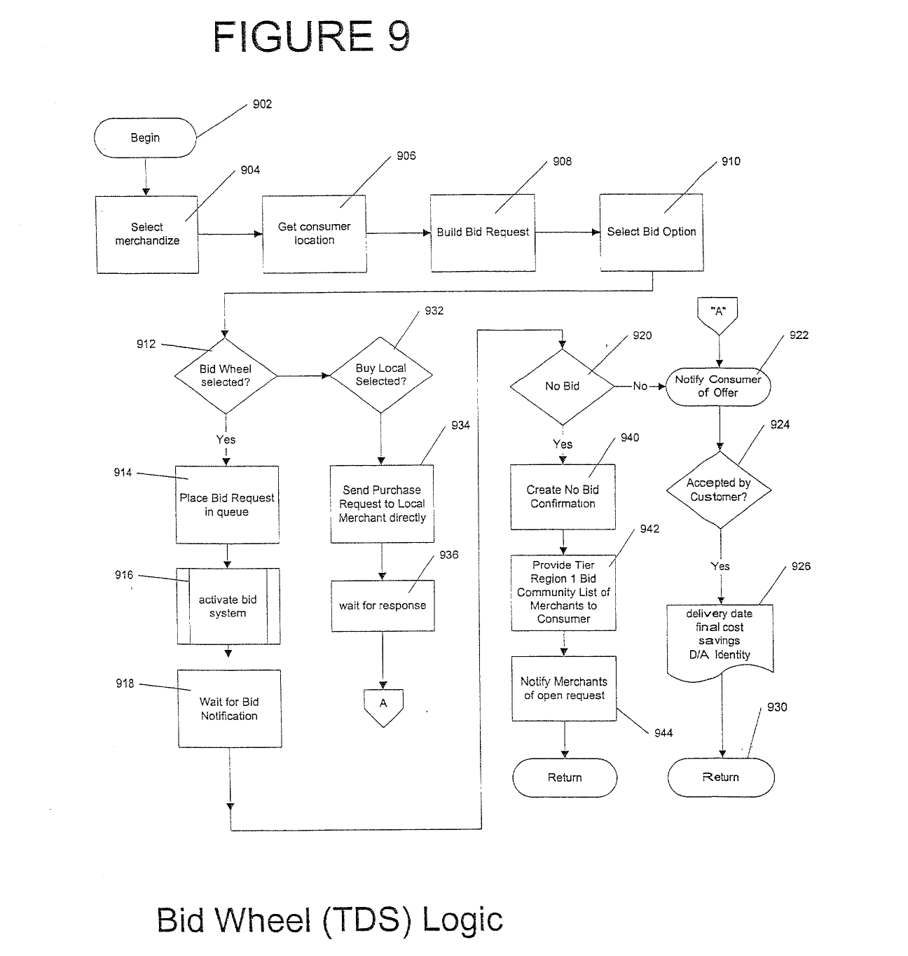

FIG. 8 is a flow diagram exemplifying the TDS system described in greater detail below with reference to FIGS. 9-12. The TDS is an integral component in the workings of BidWheel, wholesale tunneling, mobile tiering, and other aspects of the invention described herein.

With particular reference to FIG. 8, the location of the requestor, serving as an epicenter, is determined 800 through methods such as previously entered information or requesting an address from the consumer. The consumer determines if they are requesting a purchase/search for a product or service. The consumer is prompted 804 for the information required for creating a bid request. Such information includes things like product number, product/service description, manufacturer, etc. The consumer chooses the method of acquisition 806-810. If neither BidWheel 806 nor the buy-local 808 option is selected by the consumer, the catalog option 810 is offered and the consumer can select and order the product or service from the catalog. FIG. 8 conceptually illustrates 816 and 822 the BidWheel process explained in further detail in FIG. 9. In this case, the entity operating an embodiment of the present invention becomes the buyer and places the buy request 812 and 818 with the BidWheel, procuring 814 and 820 the needed item and selling it to the customer.

Continuing with the BidWheel example in FIG. 8, bid responses for the consumer's purchase request are verified and processed 824. If no bids have been received, a “no bid” report is created 826 and the bid process is terminated for the consumer's request. If no bids are received, an embodiment of the present invention can present a list 828 of merchants local to the requesting consumer, and the consumer can order the product from a local merchant at full catalog price. The consumer selects a local merchant from the list 830 and then has the choice 832 either to place an order with the merchant or terminate the purchase process 850. If the consumer places the order with the merchant, he is offered the option 834 of having the product shipped by the local merchant or placed in “will call” for pickup at the merchant's location or some other mutually agreeable location. If the will-call option is selected, the merchant is notified of the order and the consumer's request 836, and the consumer is notified with details such as how, where, when, and from whom to pick up the item and thus complete the transaction 850.

Similarly, if the consumer is purchasing an item through a catalog 810, a preferred embodiment of the present invention implements the BidWheel process 816 to request a bid from merchants. After a predetermined amount of time in which bid responses can be received 838, if no bid has been received, an embodiment of the present invention creates a “no bid” report and selects a local merchant 840 to fulfill the order. The merchant and consumer are then notified 844 of the purchase details and the transaction can be completed 850. When the entity operating the embodiment of the present invention is the consumer, a local merchant can automatically be selected to fulfill the bid request if no bids are made on the original request. The automatic selection 840 can be implemented in the BidWheel as well as buy-local or catalog purchase options. The selection of the merchant can be based on factors such as proximity to the original purchaser, price, availability, etc.

If the consumer initially selected to buy local 808, he is presented with a tier list of local merchants or service providers 828. The buy-local process then proceeds as previously described for the corresponding steps in the BidWheel process.

In any of the purchasing methods illustrated in FIG. 8, BidWheel, buy-local, or catalog purchasing, the winning bid merchant is selected from the pool of bid responses 842. Final selection can be determined based on factors such as shipping costs, sales tax, availability, location, proximity to consumer, or similar considerations. After the winning bid merchant has been selected, the consumer is notified 844 of the final purchase price, delivery date, and other pertinent information, and the transaction can be completed 850.

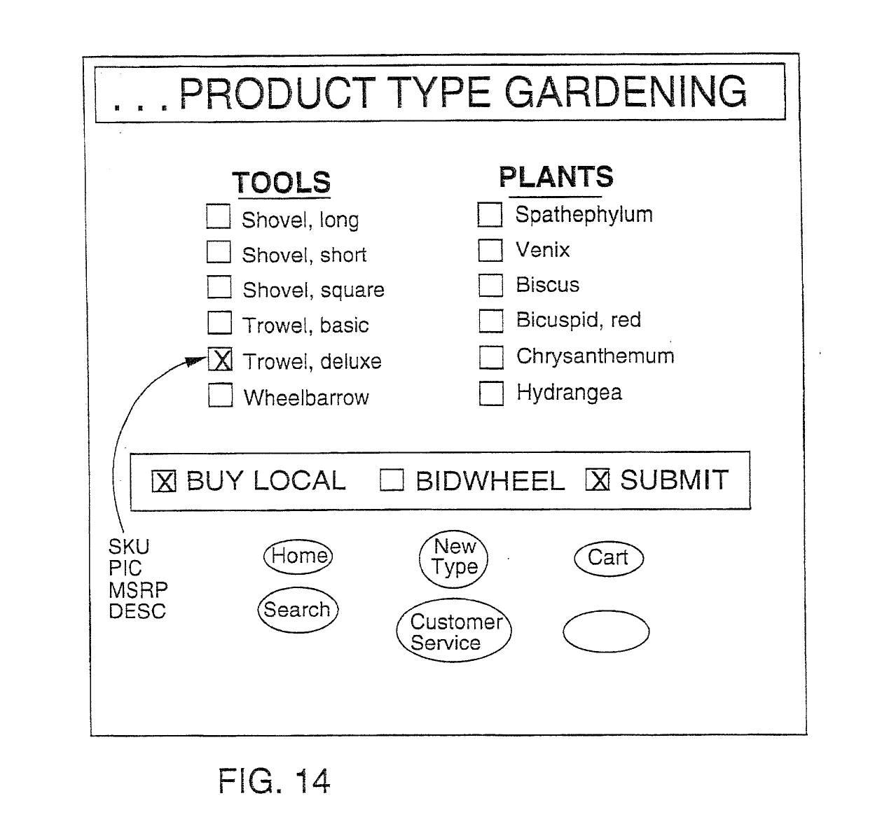

FIG. 9 is a flow diagram illustrating the TDS Logic Engine, implemented on the enterprise server. Referring to FIG. 9, the server software, beginning at 902, interacts with the customer to select a product 904, and gets the customer's location 906. The customer's location can be obtained by asking the user to enter an address, zip code, city or the like, or it can be determined automatically by tracing the user IP address or the like. Some wireless applications can provide location information using a GPS system. Location and product information are used to build the bid request 908. The user also selects either “Buy Local” or “Bid Wheel” (Tier-driven) options 910 as illustrated below with reference to FIG. 14. If the Bid Wheel is selected, test 912, the bid request is submitted 914 to a bid request queue for transmission to the tier region community as further explained below, and the bid system is activated in step 916. The system waits 918 for a predetermined period of time for a response (a bid) from a distribution associate. If no bid is timely received, test 920, the system builds and sends a “no bid” notification to the customer, step 940, and in step 942 provides to the customer a list of local (to the customer's location) distribution associates whom the customer can contact directly. These nearby merchants are the tier-1 bid community. In 944 the system also notifies those tier-1 distribution associates of the open customer request.

If there is a valid bid, see point “A” on FIG. 9, the customer is notified 922 via the Web site, e-mail or the like, and more specifically the customer is sent an offer to purchase the product the customer had requested, at the lowest valid bid price, subject to adjustment, e.g., due to a commission or special promotion. Optionally, the offer can indicate a time limit during which the offer can be accepted and beyond which the offer is deemed withdrawn. If a time limit is indicated, the system waits for that period of time 924, e.g., an hour or a day, for an indication of acceptance of the offer by the customer. If timely received, then acceptance forms a binding sale contract (at least in the United States). The customer is then notified 926 of the expected delivery date, final cost savings, distribution associate identity, etc.

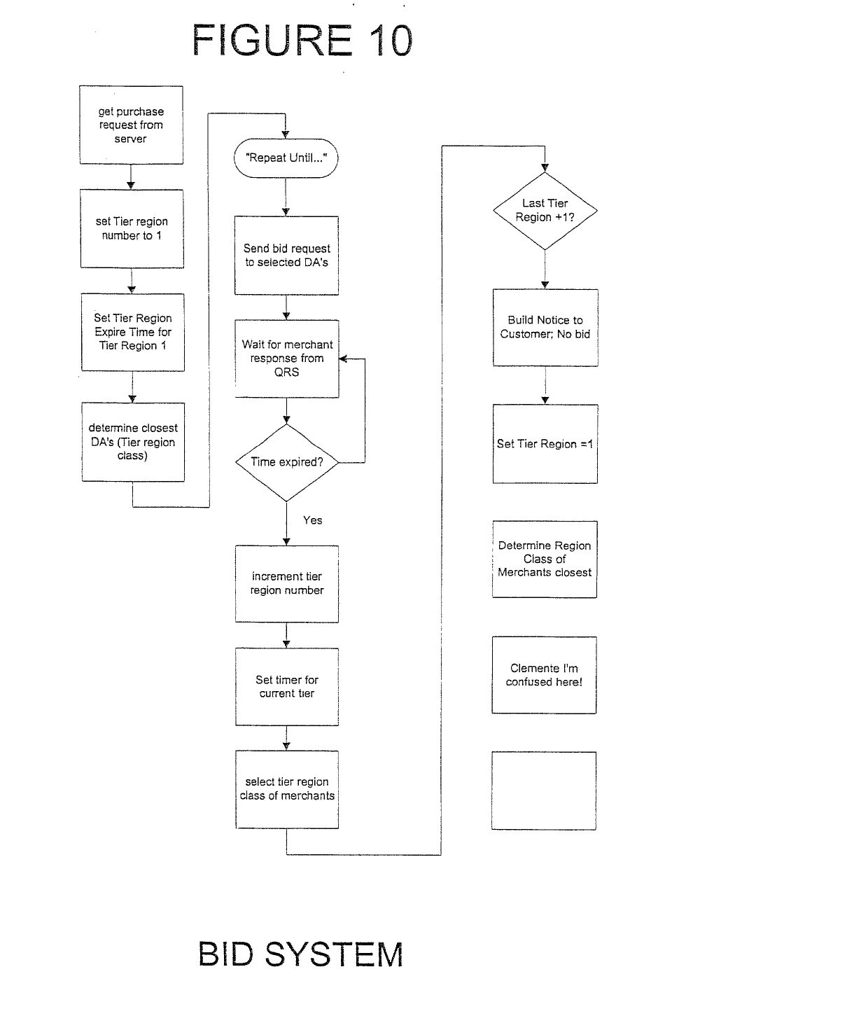

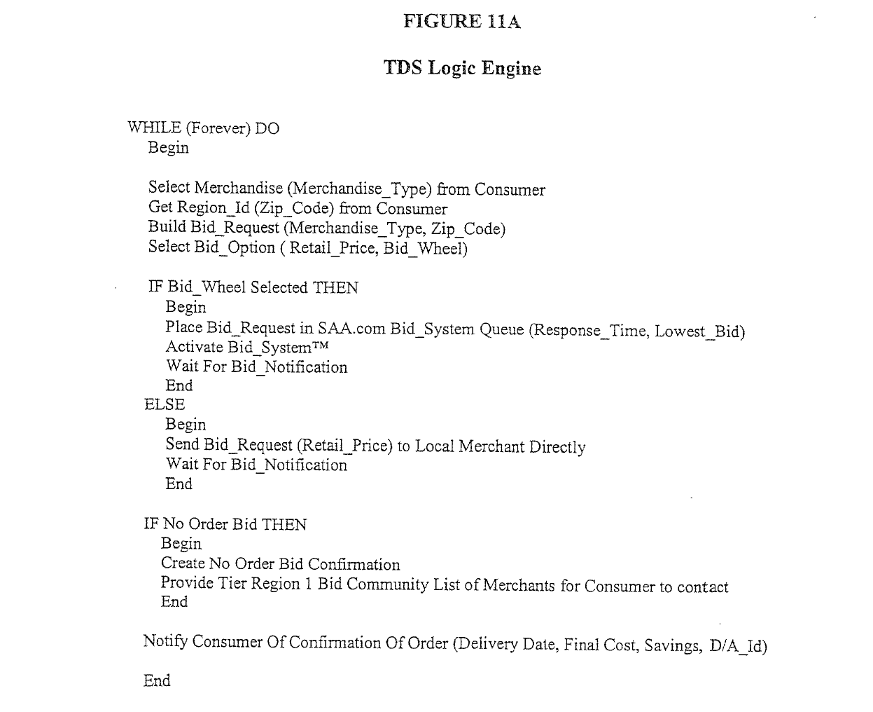

FIG. 10 is a flow diagram illustrating the Bid System logic. The bid system handles the details of tracking tier region numbers, time limits and elapsed time, sending out bid requests, waiting for merchant (D/A) responses (bids), and sending bid requests to successively larger tier regions if necessary as explained above.

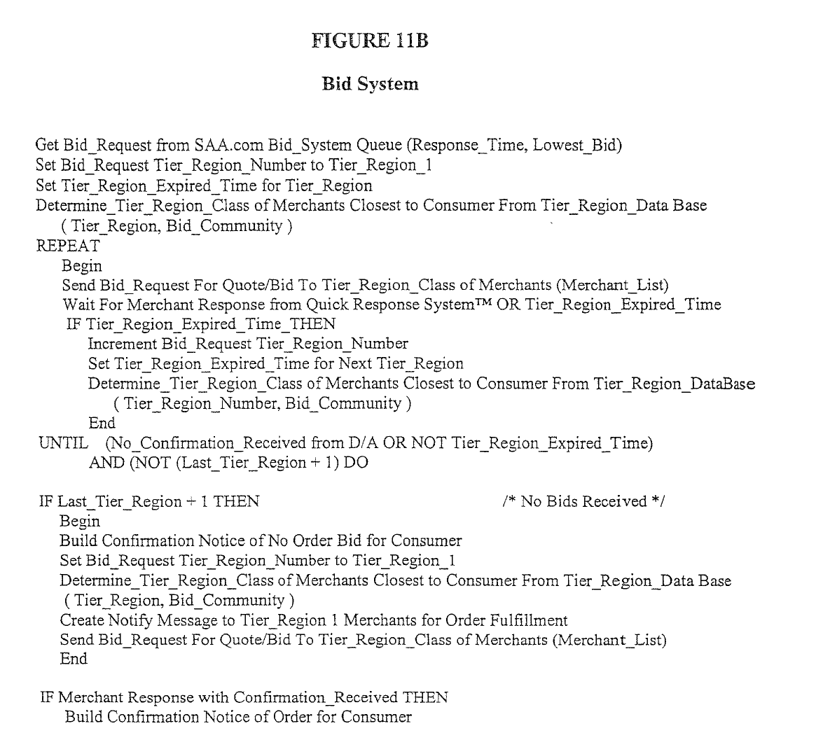

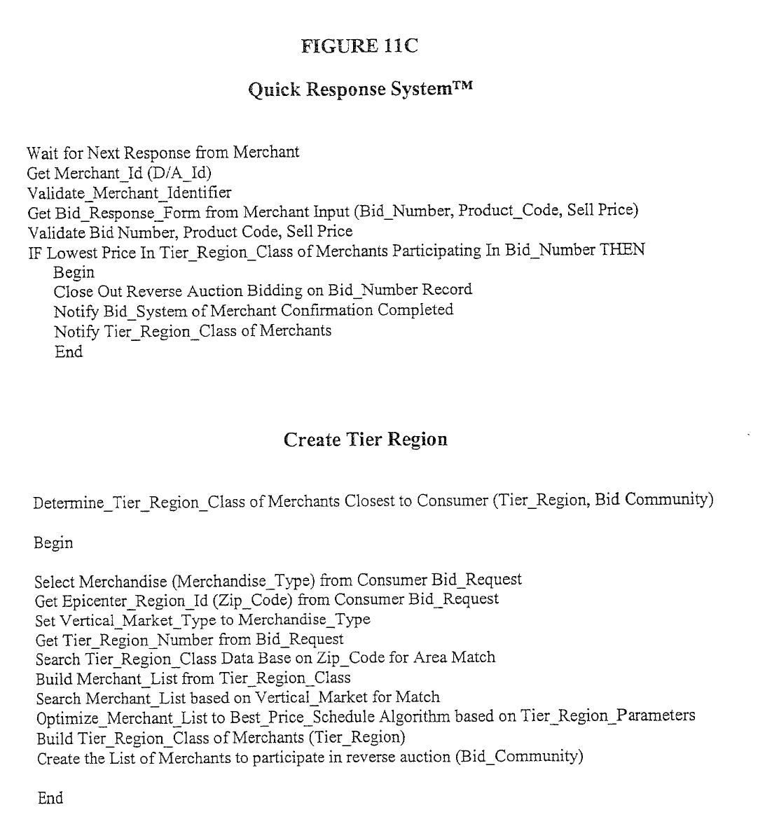

FIGS. 11A, 11B, and 11C are pseudo-code descriptions of the TDS logic engine, the TDS bid system, the Quick Response System, and the Create Tier Region logic of FIG. 8. These structured language descriptions generally reflect, albeit more formally, the associated flow diagrams and narrative descriptions herein. They illustrate one example of a software architecture for implementing the invention although many different solutions can be used, in a variety of programming languages and operating systems, the details of which are known by those skilled in the art.

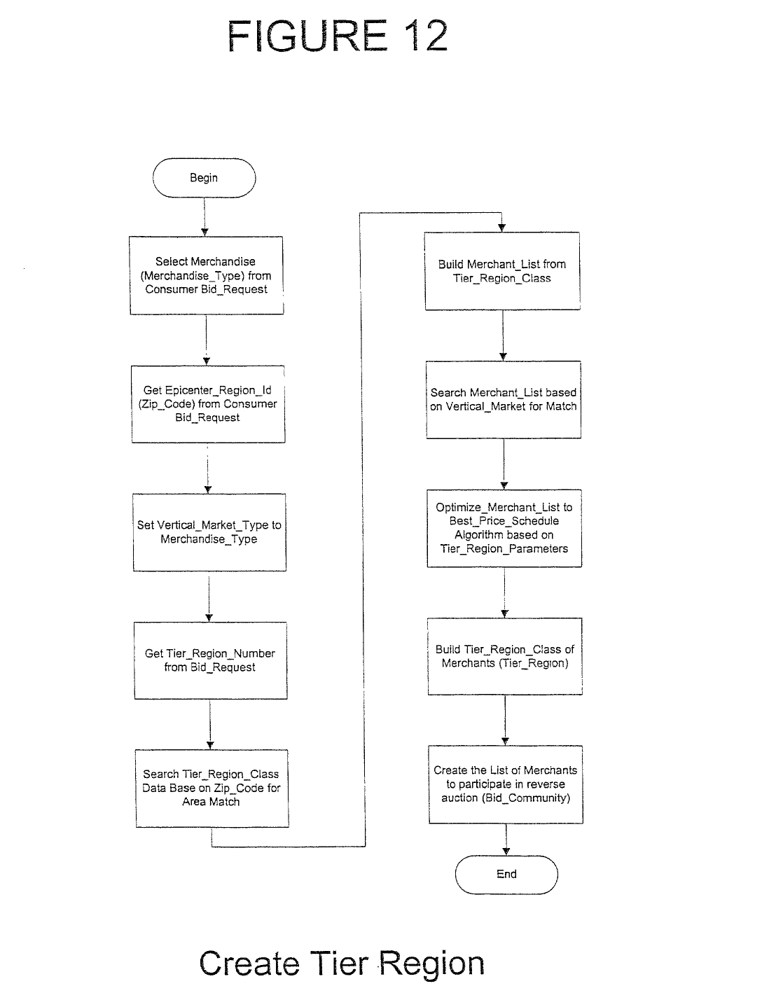

FIG. 12 is a flow diagram illustrating Create Tier Region logic. The steps of this process are described in pseudo-code set forth in the drawing. Most of these steps have been explained earlier. The variable “vertical market type” corresponds to the product category, e.g., those illustrated in the Web page of FIG. 13, described shortly. Each distribution associate, at the time of registering to participate in the centralized, tier-driven server system enterprise, designates those product categories in which the merchant regularly trades or would like to do business. The phrase “optimize merchant list to best price schedule algorithm based on tier region parameters,” refers to taking shipping costs into account in defining a tier region community, utilizing the database information mentioned earlier with reference to FIGS. 6A and 7.

FIG. 13 illustrates an example of a Web page implemented on the central Web site (208) as displayed on the customer's Web browser. The particular design of the Web site is a matter of design choice, but the primary shopping page preferably would include the following elements. First, the masthead 1302 identifies the central Web site sponsor, i.e., the enterprise (illustrated as “Shop all America.com”) with which all of the distribution associates are affiliated by contract. A list of predefined product categories 1304 is displayed, comprising links to more detailed information. A search component 1306 enables the user to search for a product or service by keyword(s). An enterprise store locator feature allows the user to find a distribution associate in her area, for example by entering a merchant name, or the user's address, city or zip code. A “featured store” component would include a photograph of a selected distribution associate and a brief description of that merchant, with appropriate links. Another optional feature is a display 1320 of “Today's In-Stock Inventory Value” showing an estimate of the value of the combined inventories of all of the distribution associates in the categories of products offered on the site. This is likely to be a huge number, illustrating to the customer the power of the present tier-driven system, aggregating the offerings of many retail distribution associates. Other more conventional Web site features may be included as well, such as a “Learn More About Us” button, company profile, order information, and help links. A selection of “featured items” (that changes frequently) can be included, with thumbnail photos, and each with a “find store” link 1312 that can be used to locate a merchant (a distribution associate) who offers the product.

FIG. 14 illustrates a more specific Web page of the type that would be displayed in response to the user selecting a particular product category, in this example, gardening. The gardening page displays a list of gardening products (it could include gardening services), here shown under subcategories “tools” and “plants”. Each individual product includes a brief description, and can have links to more detailed information, photographs, etc. as is conventional at shopping sites. The user selects a desired product, and selects either “Buy Local” or “Bid Wheel” options. The former choice indicates a desire to buy the product only from a local merchant. The “Bid Wheel” option refers to the tier-driven process described above. The user clicks “submit” and this form implements the “purchase request” sent to the central Web site to initiate the purchase process.

A preferred embodiment of the present invention also affords small merchants an extensive system for inventory management. Often a local merchant is in the position of being asked for products or items that they do not have in stock. Typically, the only inventory resource for a small merchant is the manufacturer, a distributor, and maybe a few friendly merchants in the surrounding area. Limited inventory sources limit a merchant's ability to make sales to customers. The present invention, however, provides merchants with access to numerous other similar small business merchants, and a merchant needing inventory can cheaply and quickly query the other merchants to obtain the desired item. This concept is referred to as “wholesale tunneling” because, while it can procure items for customers, the customers often do not observe the process.

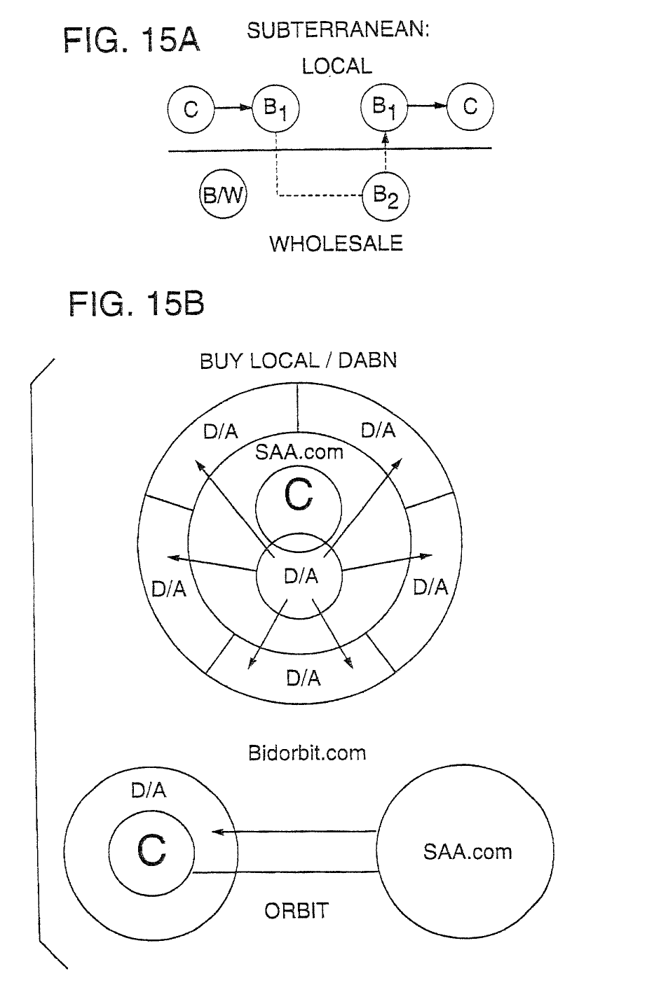

FIG. 15A illustrates the process being used by a distribution associate to obtain an item from another distribution associate, an example of a wholesale purchase. This can be used to fulfill a pending customer request. In FIG. 15A, the customer “C” uses the enterprise Web site as described above to request a product. The Web site TDS sends a bid request to a first distribution associate “B1”. The retailer B1 wants to respond (bid) but does not have the requested product in inventory. Therefore, B1 sends a wholesale purchase request back to the TDS, indicated as “B/W” for Bid Wheel. The TDS in turn sends wholesale bid requests (corresponding to B1's request) to other distribution associates, beginning with an initial tier region, and expanding to additional tier regions as necessary. In other words, the wholesale system uses the same strategy as the retail tier region system. A second distribution associate B2 submits the winning wholesale bid, and the TDS duly sends a corresponding offer back to B1 (again analogous to the retail communication process described earlier). B1 accepts that offer, purchases the product at wholesale from B2, and then resells the product (through the TDS/web site) to the customer C. The wholesale purchase is transparent to the customer.

FIG. 15B further illustrates this wholesale concept. It shows a distribution associate at the center (local to the customer), and the enterprise server (“SAA.com”) broadcasting bid requests to a first tier region of distribution associates. For example, when a distribution associate responds to a (retail) customer bid request, the merchant might indicate essentially “yes, I want to bid, but I don't have the inventory; please send wholesale bid requests for me.” Within a matter of minutes or hours, the merchant will receive an offer based on the lowest (wholesale) price valid bid submitted by another dealer. He can accept it and then complete the resale. The retailer may be able to arrange “drop shipment” from the other dealer to the customer.

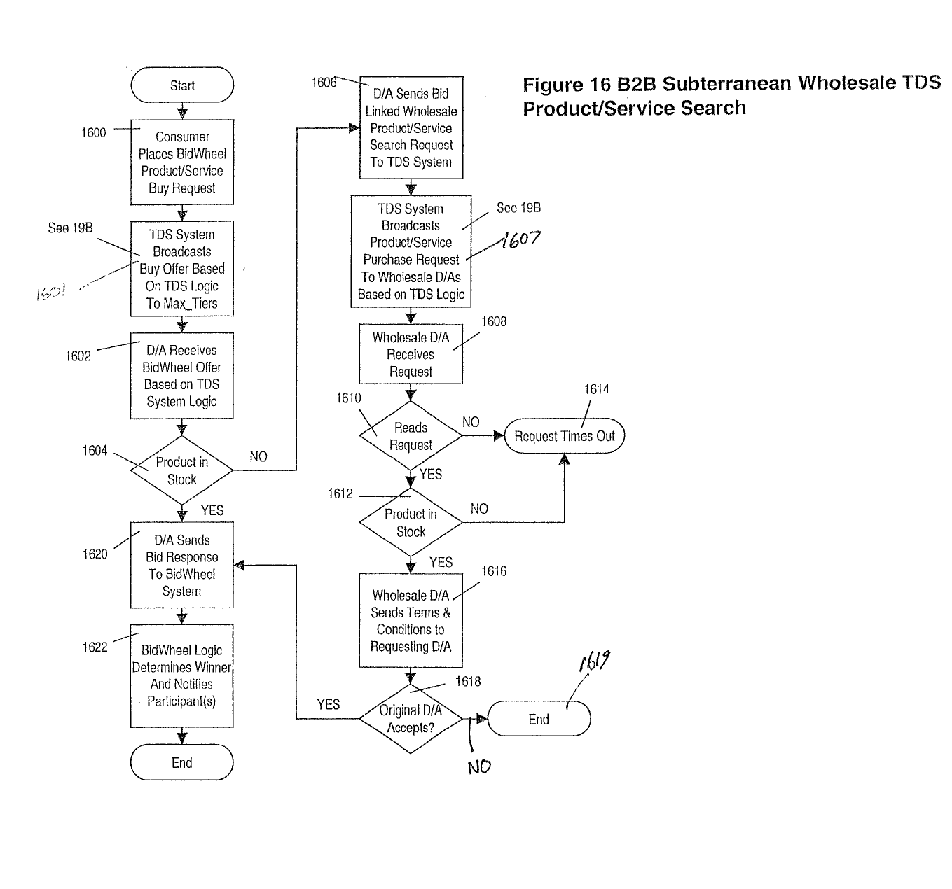

The concept of “wholesale tunneling” is further illustrated with the flow diagram of FIG. 16. The process begins with a customer placing a BidWheel request for a product 1600, and the tier-driven server (“TDS”) distributes the request to participating D/As 1602 according to a predefined logic or algorithm 1601. If a D/A receiving the request has the product in stock 1604 and chooses to participate, the D/A can use the D/A aspect of the BidWheel system to bid 1620 on the product, or the D/A can use the D/A wholesale tunneling aspect to search 1606 for the product in the inventory of other D/As. With wholesale tunneling, the D/A uses a process similar to that used by a consumer to place a request for a product, except that the wholesale request is sent to other D/As 1607 that have agreed to function as a wholesale co-op and sell products to other D/As at a price that allows them to resell the product to the requesting consumer. Once the participating wholesale D/A receives 1608 the request for a product they can read 1610 the request and decide if they have the product in stock and would like to respond. If the D/A does not read the received request, or if the product is not in stock, the search request will time out 1614.

If the wholesale D/A reads the request 1610 and has the product in stock 1612, they can respond with terms and conditions 1616, such as price, shipping costs, condition, etc., to the requesting D/A. If the original D/A accepts the wholesale D/A's offer 1618, then they will complete the bid cycle by responding to the original BidWheel request of a customer 1620, and it can appear to the customer as if the product was always in stock with the original D/A. If the original D/A does not accept the terms or conditions, the process is terminated 1619. The process completes when, based on the predefined BidWheel logic (see FIG. 9), a winning bid is selected 1622.

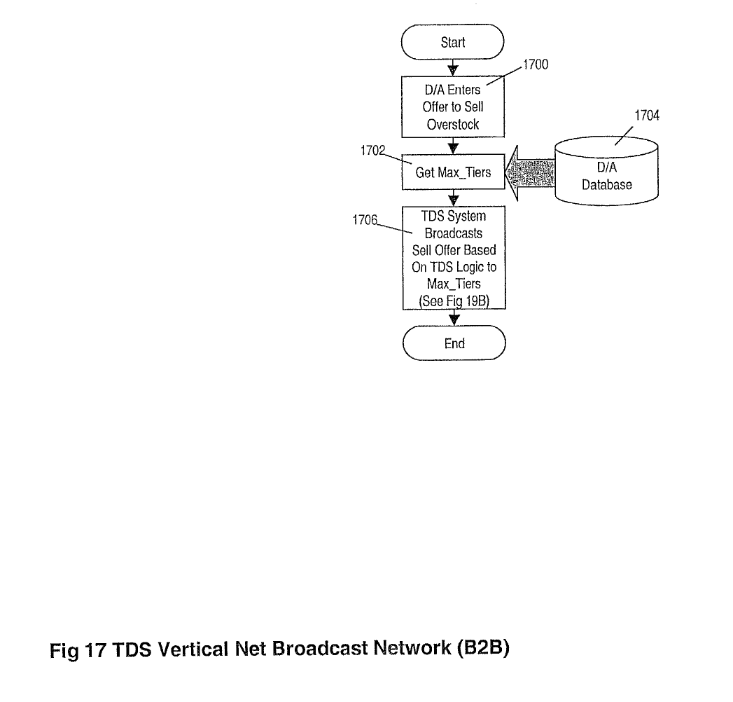

FIG. 17 depicts a system for providing a “TDS Vertical Net Broadcast Network.” The Vertical Net Broadcast can be implemented effectively in a B2B context. It can be used to solve the problem of selling overstock inventory or purchasing new inventory from non-traditional channels. Through the merchant network that is created by the Vertical Net Directory, the small business person will have access to other small business owners that can be queried for sales or purchases.

To conduct a Vertical Net Broadcast, the merchant creates an e-mail offering 1700 to sell or buy inventory. As part of this process the merchant answers questions that allow the TDS to determine the scope of the broadcast. For instance, if a merchant wanted to buy or sell a large item at wholesale, like a hot tub, they would tell the TDS to only distribute the offer to other D/As within a one day round trip of the requesting D/A. On the other hand, if the D/A was offering or looking for a product for which shipping is not an issue, they could expand their tier to include D/As further away from the requesting D/A. Based on the guidelines of the offer 1700, the TDS will query the D/A database 1704 to determine the maximum number of tiers 1702, identify D/As in the D/A database 1704 in the same vertical market as the inventory offer/request, and create a list of qualified D/As. The TDS will then broadcast or send out 1706 the original offer 1700 to qualified D/As selected from the D/A database 1704.

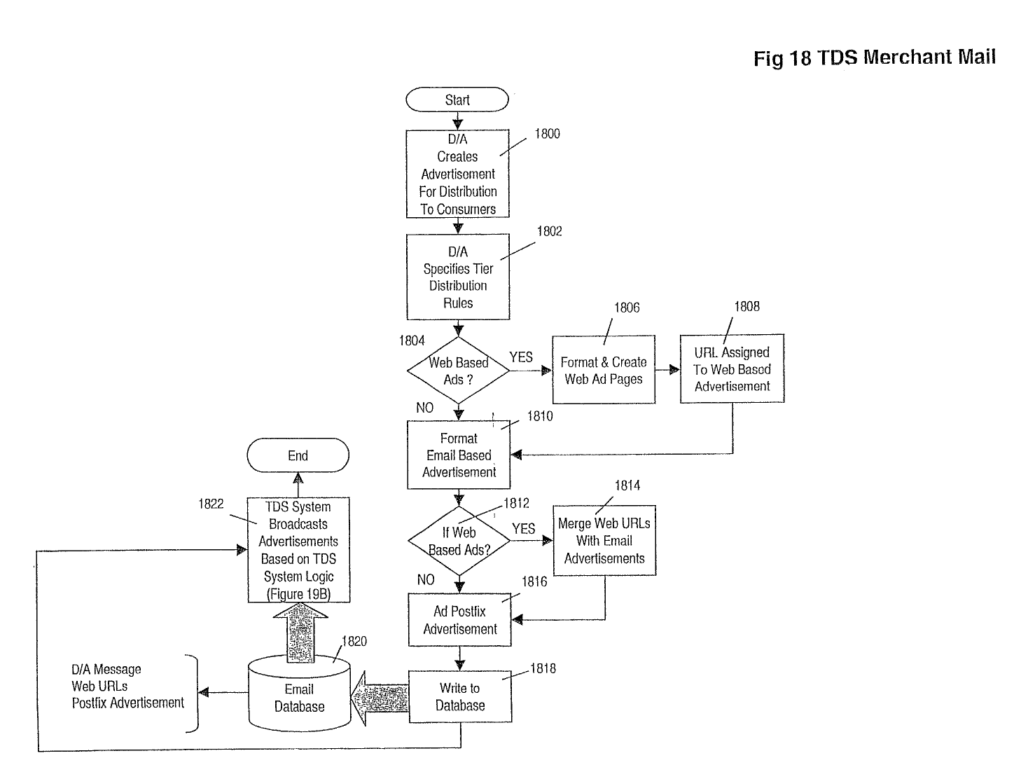

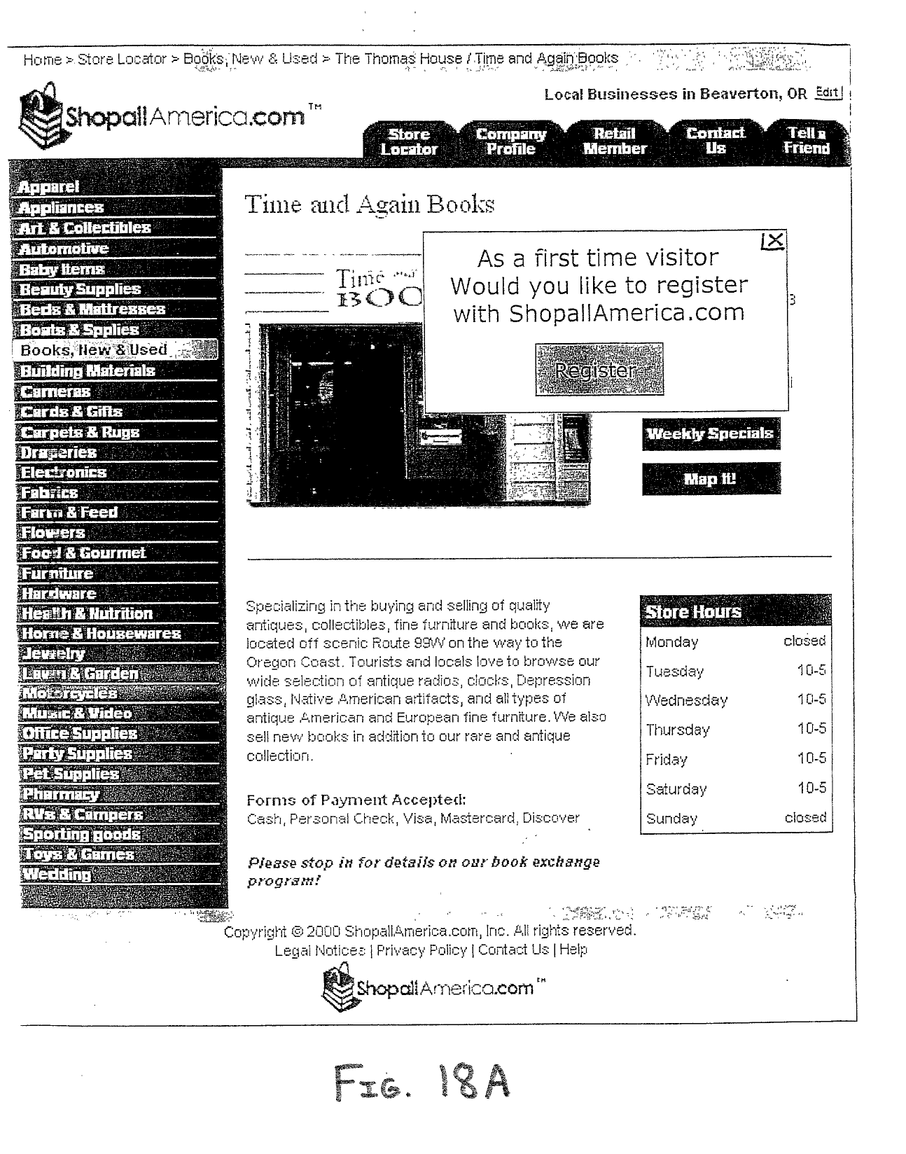

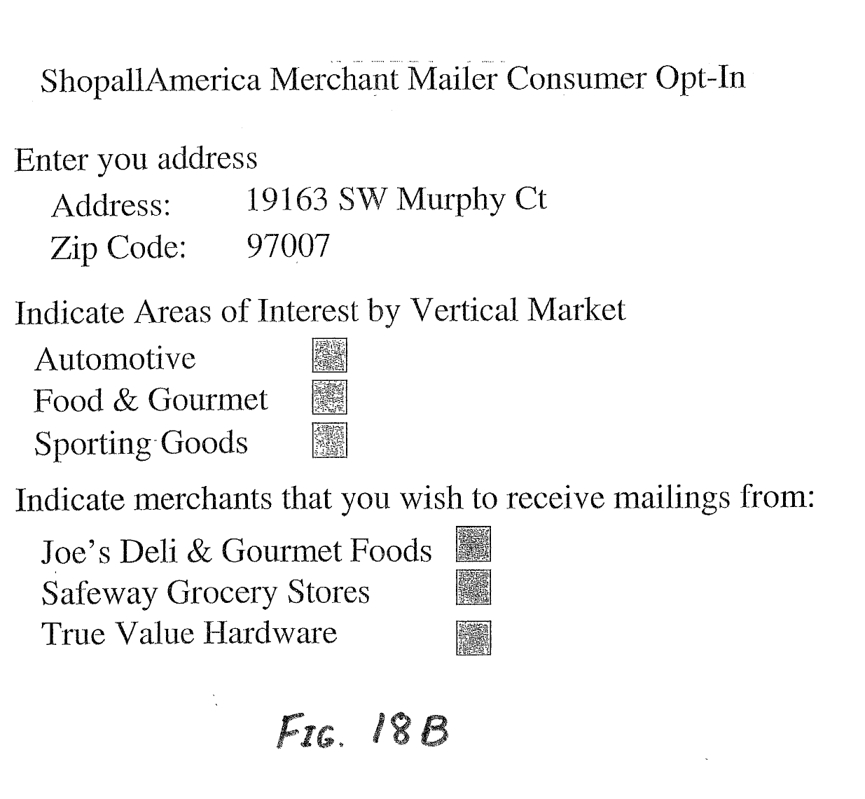

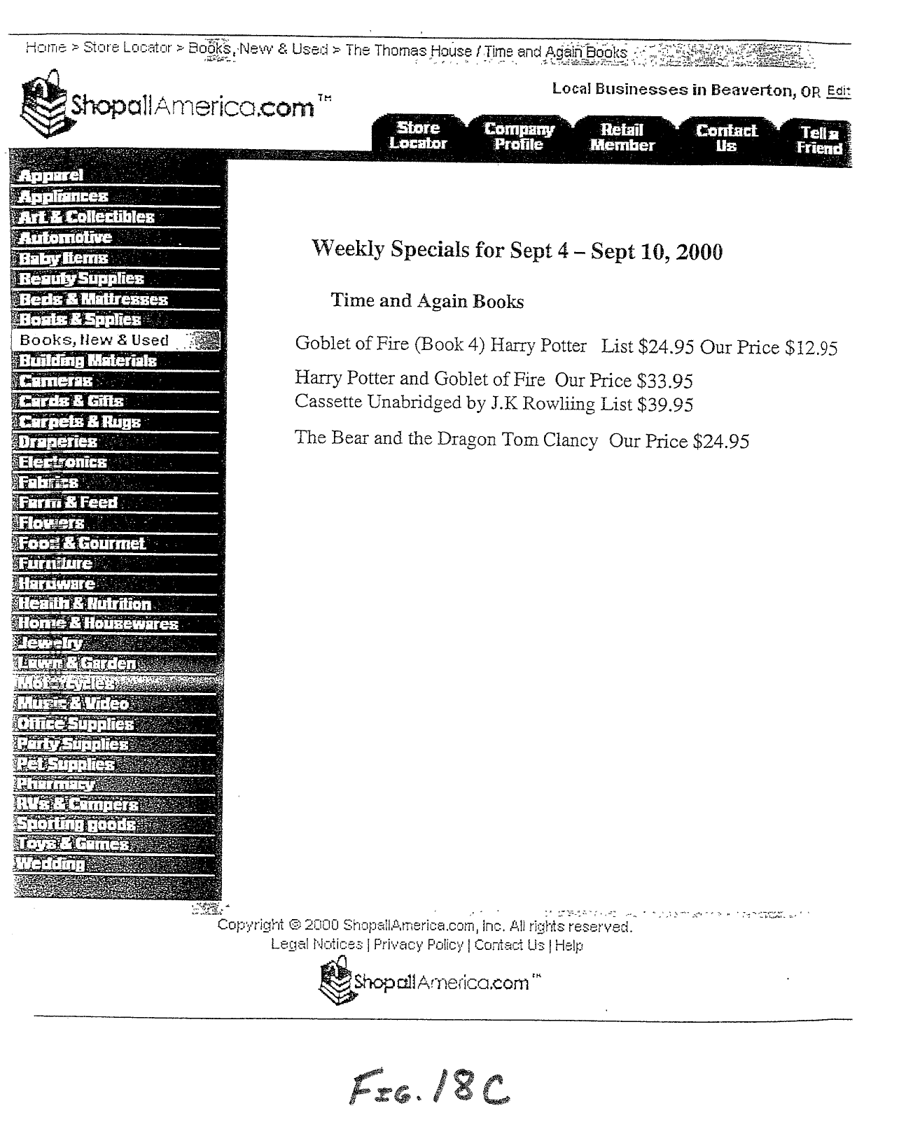

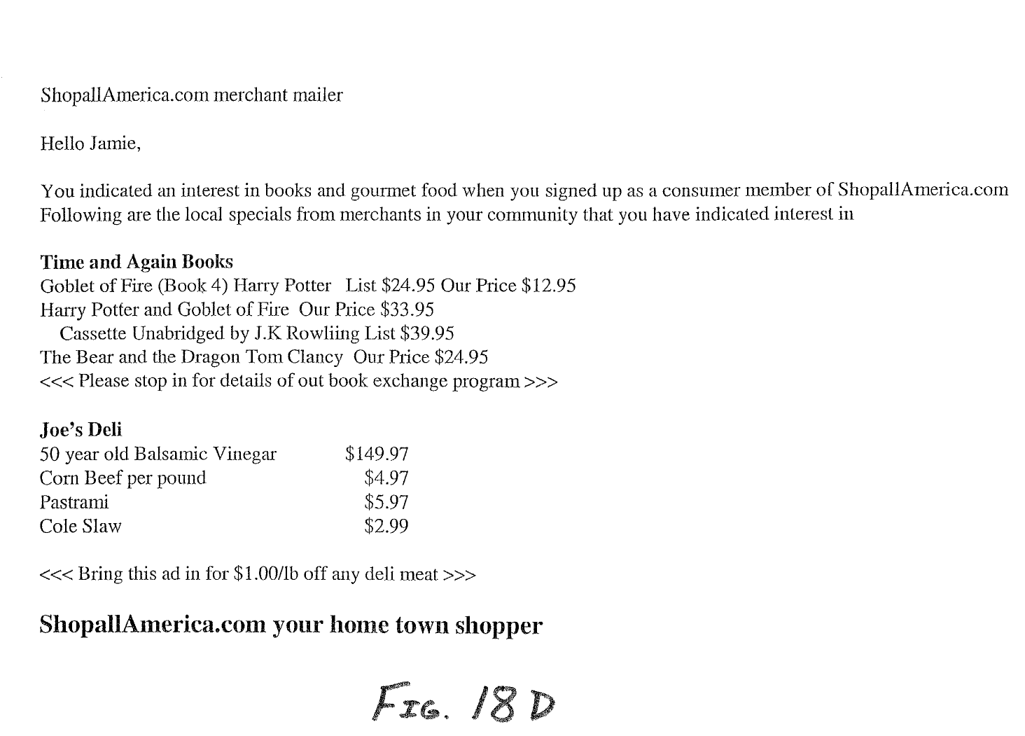

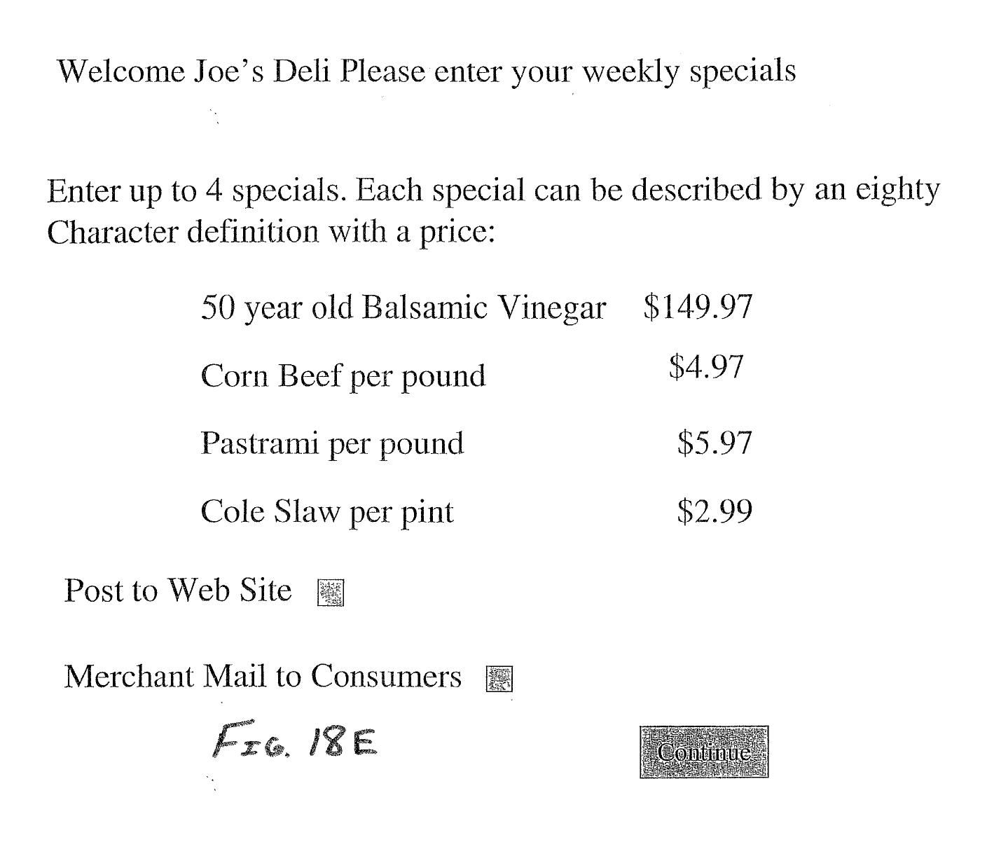

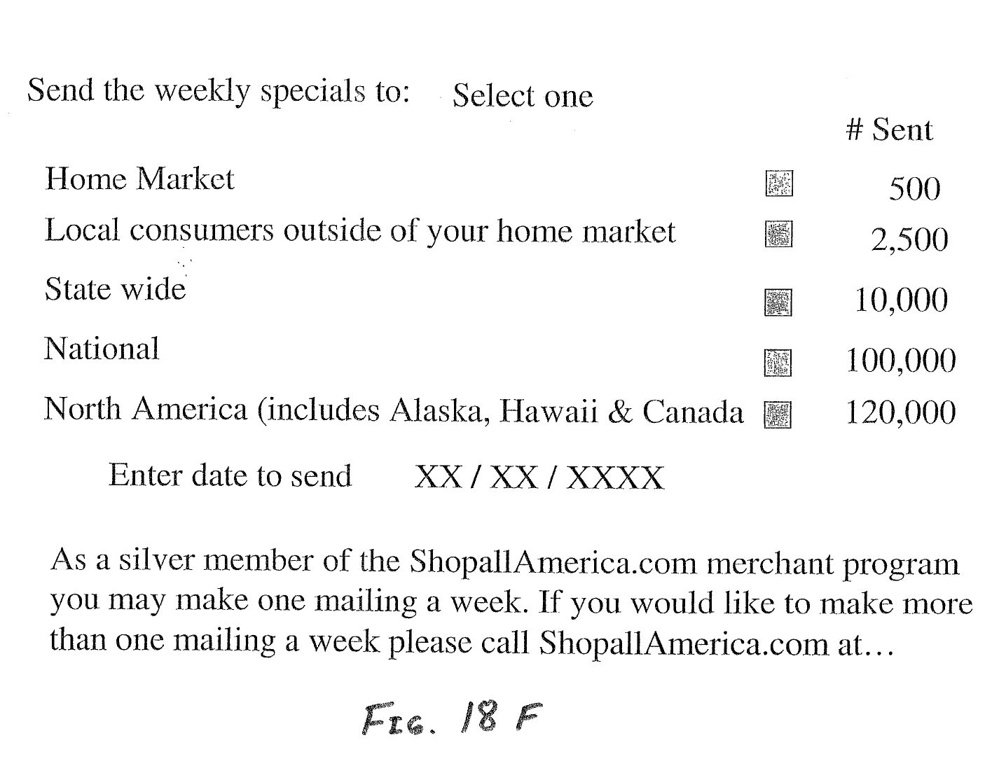

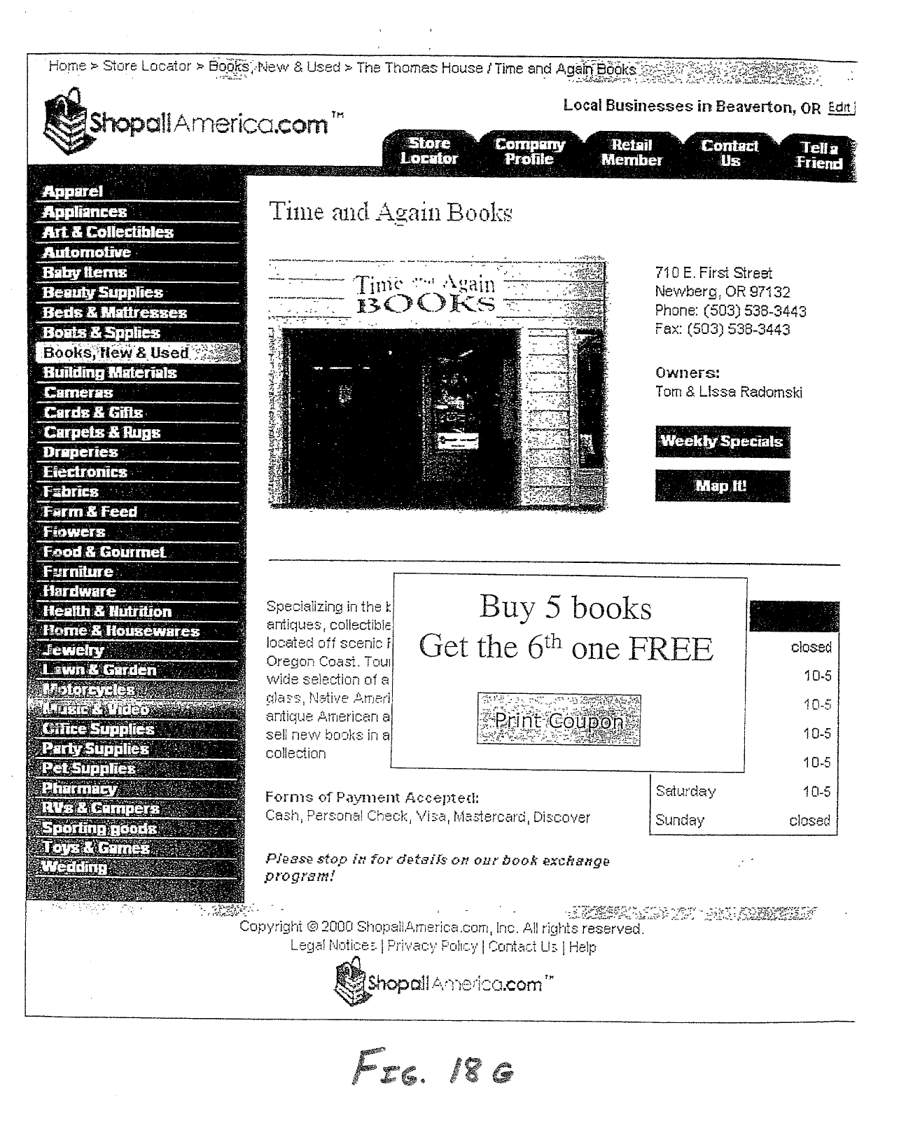

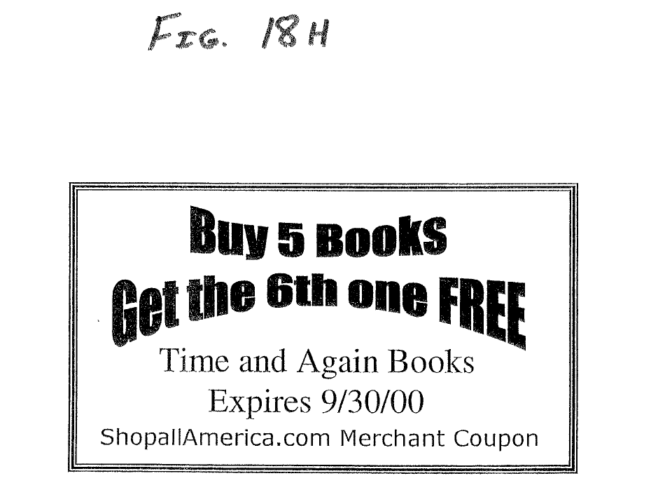

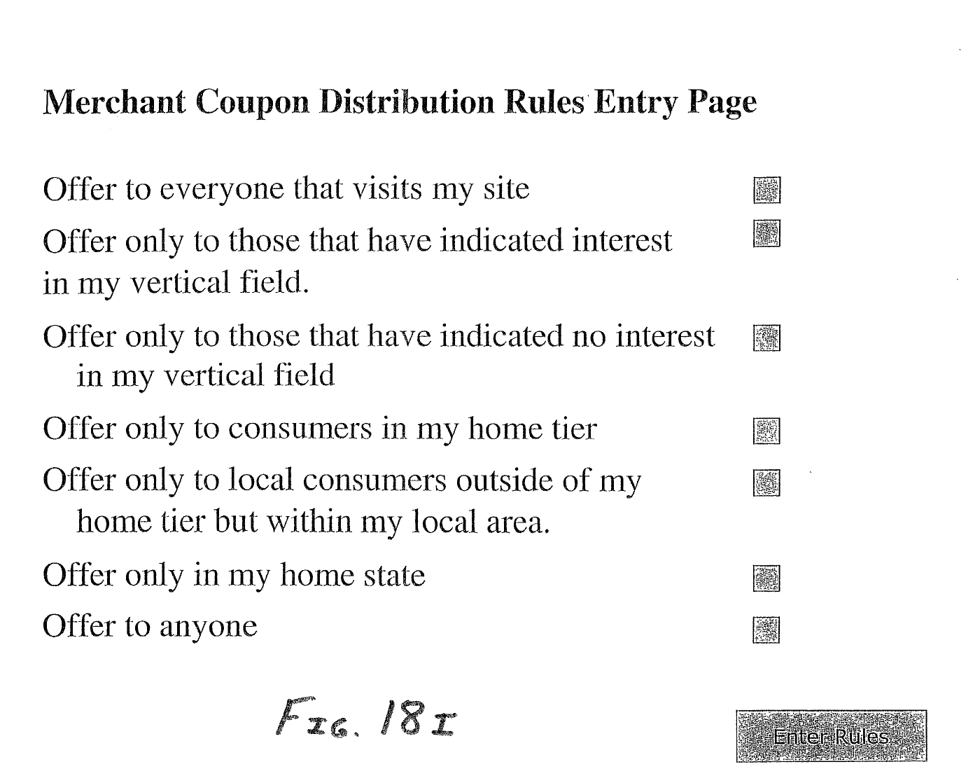

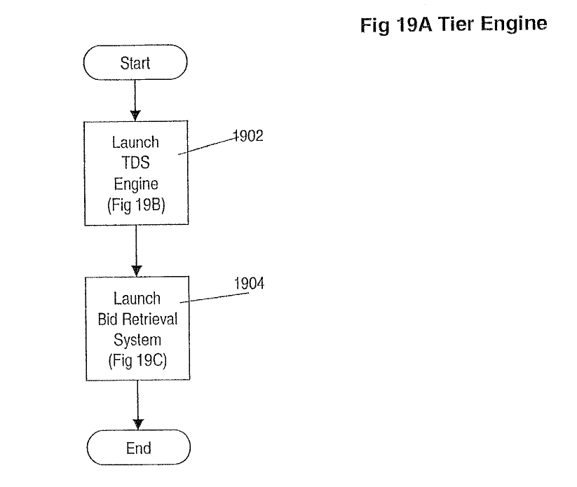

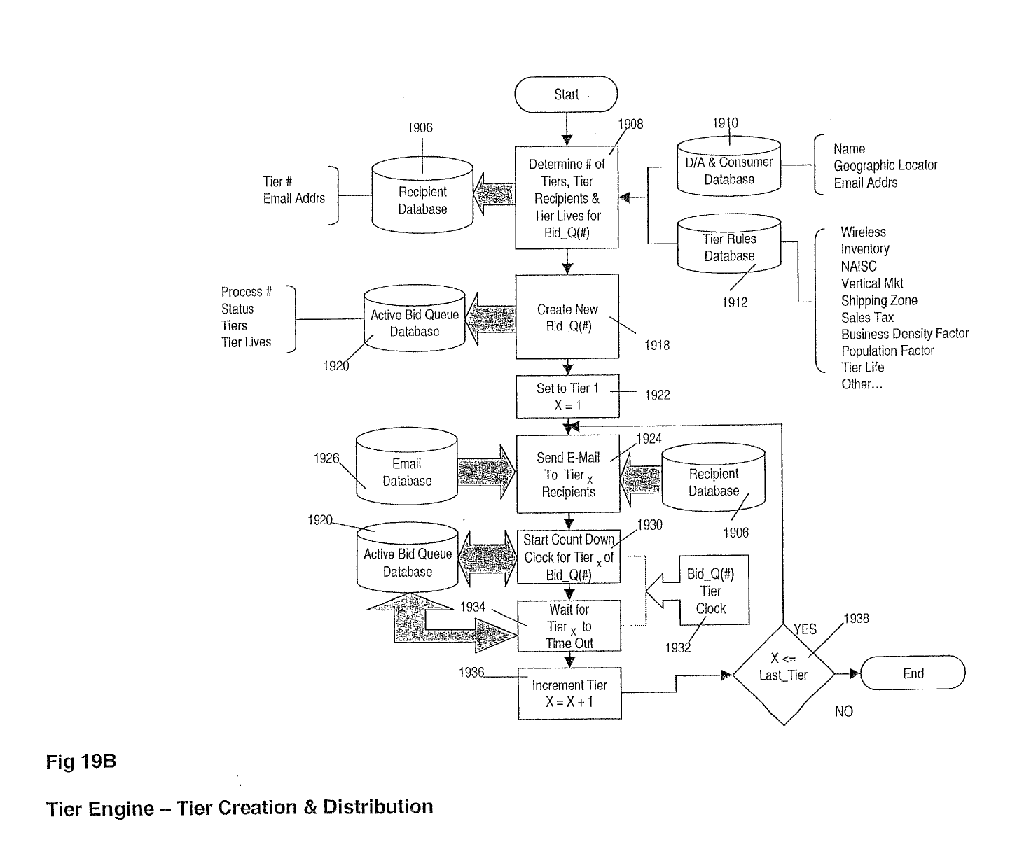

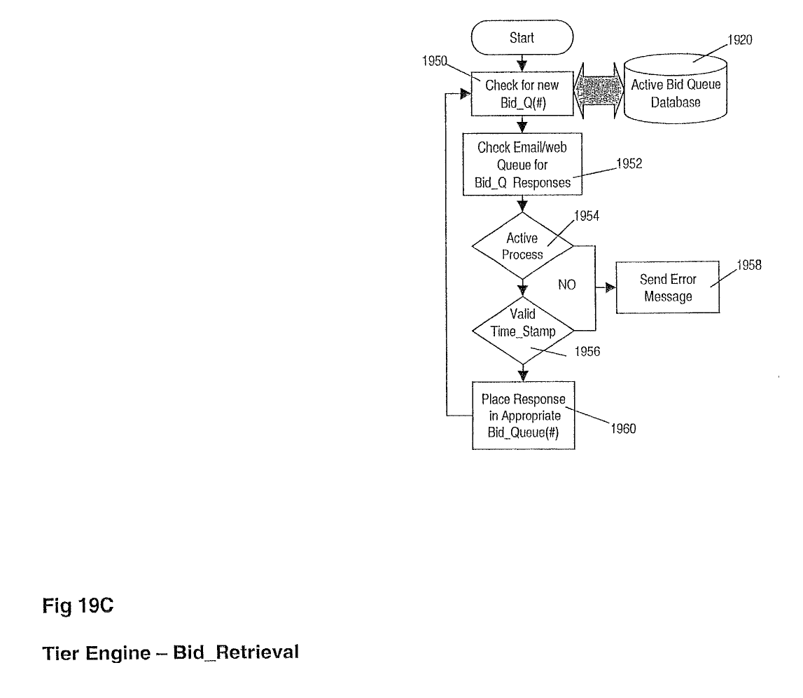

FIG. 18 represents an aspect of the present invention termed TDS Merchant Mail. Merchant Mail solves problems faced by many small businesses when trying to advertise special sales or similar messages to potential customers. Currently, a merchant is confined to limited and expensive options for advertising their products. These options include newspaper ads, cold phone calls, direct mail, circulars, window banners, etc. While these methods can be somewhat effective if used by an experienced merchant that has invested time and money in learning the needs of their community, the typical merchant does not have the time or money to invest in learning this type of advertisement. Merchant mail solves this problem by allowing a merchant inexpensively to create targeted ads and deliver them in a timely fashion at almost no cost. The typical direct mail campaign costs a merchant between $0.50 cents and $1.00 per delivered piece. Coupon flyers and newspaper ads, while significantly less expensive are, at best, generally targeted only to the zip code level of specificity.

Implementing an opt-in list of targeted consumers, the merchant can e-mail advertisements to consumers that have indicated interest in either the products carried by the merchant or in a specific store. Contacting a targeted list of consumers that have previously indicated interest in the products carried by the merchant has been shown in studies to be two to three times better than a typical direct mail campaign. Further, with tiered advertisement groups, the merchant can try different types of ad campaigns. For instance, the merchant could offer a discount to consumers that are not in the home tier of the merchant to encourage them to travel farther to shop at the merchant's store. Similarly, the quantity of the offered discounts can increase the further a potential customer is from the merchant's store.

It is often hard for the new and small manufacturer to get a product broker to represent them, requiring the owner of the business to do their own product sales. Often this is an overwhelming task for the small businessperson. Also consider the small manufacturer that is located in a geographically isolated location, such as a craftsman living in a small town, a gourmet food producer that needs to live close to its suppliers, or a person in a foreign land that wants to market to merchants globally at as low a cost as possible. Merchant Mail gives the small manufacturer a low cost way to present their products either to targeted merchants or consumers. Through the use of Merchant Mail, a merchant could target potential purchasers without the expense of creating and mailing brochures or using an in-person sales force.

FIG. 18 depicts a flow diagram representing the Merchant Mail process. The process begins when the D/A creates their message 1800 through media such as a specialized Web page, e-mail, or a fax message. D/A specifies the delivery rule for the outgoing e-mail 1802. For example, the D/A could choose to mail only to its home tier or to a specified number of tiers around the merchant. This would allow a merchant that was only interested in mailing to a local audience and a merchant that was interested in selling nationwide or worldwide to target their delivery audience by selection of the tier coverage. Tier delivery options could also allow for delivery of a different advertisement for the same product to each tier within a community.

If the D/A has created merchant mail that requires a World Wide Web page interaction 1804, then the process flow is directed to an application that will dynamically create the page. The Web page creator dynamically creates the required Web page 1806. The Web page creator assigns a uniform resource locator to the page that will be sent out with the final e-mail 1808.

After the URL is assigned 1808, or if no Web-based implementation is necessary, the TDS formats 1810 the input created by the D/A to look substantially the same regardless of the type of e-mail client used by the reader. If a Web-based advertisement is included with the offer 1812, the URL can be merged with the e-mail text 1814. Otherwise, the address can be postfixed to the e-mail 1816 and the TDS writes the completed e-mail to the outgoing e-mail database 1818. Finally, the TDS can inform the Tier Creation and Distribution process of the new e-mail and queue the mail to the mail server 1822.

FIGS. 18A-18I depict examples of various screen shots, mail messages, postfixed offers, broadcasts, alerts, user interfaces, and the like, that can be used in implementing the merchant mailer and vertical net broadcast aspects of the present invention.

FIG. 19A shows detail of the Tier Driven Server process. Distribution of e-mail messages and receipt and redirection of bids by the D/A are handled by two processes, the creation and distribution process 1902, and the bid retrieval process 1904. The bid creation and distribution process is multi-threaded and new processes are started as needed to support bid creation. The bid retrieval system is a stand-alone process that parses and directs incoming bids to either the BidWheel system or redirects e-mail to the appropriate D/A.

FIG. 19B schematically illustrates the system in greater detail. In particular, FIG. 19B illustrates database of e-mail addresses 1906 that will be used to direct the e-mail output of the tier engine. This database is created for every tier driven delivery process and contains the e-mail address of all recipients with their associated tier number. The logic engine of the tier engine routinely scans the D/A and consumer database(s) using a set of rules that have been dynamically determined by the logic engine to create a set of dynamic tiers 1908 with a dynamic tier life with either the consumer, the D/A and in certain cases the consumer and the D/A as the centroid(s) for the tier determination algorithm. The rules for tier determination can be dynamically determined based on the following types of information: location of a wireless apparatus, inventory amounts of the D/A, vertical markets, NAISC codes, shipping zones of a preferred shipper, sales tax laws, business density factors, population, and other statistical information that can be derived from sources to be determined.

Other databases 1910 and 1912 contain the base information needed to determine tier parameters, the list of potential e-mail recipients and the rules database. The recipient database 1910 includes a geographical locator for every person in the database. The geographical locator can be as simple as a zip code, a geocode, longitude and latitude or other information to be determined such as a cell phone number to be used to determine a location in real time. The rules database 1912 is a combination of statistical data and relational rules for the statistical data. These rules are parsed by the logic engine and used to weight the statistical data to create tiers that will create optimum bidder pools.

The BidWheel needs a bid queue 1914 to hold incoming D/A responses to a customer request. Other processes such as Merchant Mail, Vertical Net Broadcast and the wholesale tunneling process do not use the BidWheel logic to select a winning bidder, and therefore do not require the creation of a bid unique bid queue. When creating a tier-determined broadcast without a bid response period, the tier life can be set to zero 1916 so that e-mail is sent out without a wait between tiers. For instance, Merchant Mail is tier directed in that different mail can be sent based on tier location, but there is no reason to wait between tiers as there is in a bid situation. Each bid scenario or process requires a unique bid queue for two reasons: one for the bid retrieval system to queue responses to for each consumer request; and two, so that other independent processes know that a new process has been started and the status of that bid process.

Another database 1920 contains the entire active bid processes along with the current status of the bid process. The TDS is then initialized 1922 to the first, home tier. Next, the TDS merges and formats the e-mail message 1926 with the recipient(s) from the recipient database 1906 and queues the results to the mail server 1924. FIG. 19B also depicts the e-mail database that contains the e-mail 1926 message created by the D/A or the BidWheel for distribution to recipients within a tier area.

Once all of the outgoing e-mail messages have been queued to the e-mail server, the countdown timer starts. This process, besides determining when the next batch of e-mails should be sent, maintains the active bid process flags for the bid retrieval process 1930. A real-time clock 1932 can also be used to monitor all time sensitive processes. When the active tier started in box 1930 times out, the process terminates. Before passing control to the next process, the active bid queue database is updated to indicate the termination of the current tier 1934. The tier counter is then incremented to the next tier 1936. If the last tier has been processed, then the TDS terminates the process. Otherwise, it returns to the send-mail process 1924 to queue the mail for the next tier 1938.

Continuing with FIG. 19C, the process checks for new bid processes, and if one is found, it adds the process to its list of known and active processes 1950. The bid retrieval program can then check for input Web or e-mail bids 1952. When a bid is found, it is checked to verify that the bid is for an active process 1954. If the process is active, then the bid is checked to verify that the bid is within its active tier time window 1956. If the bid fails either the active process check 1954 or the time-out check 1956, then an error message is sent to the bidder 1958. The validated bid can then be put in the appropriate bid queue 1960.

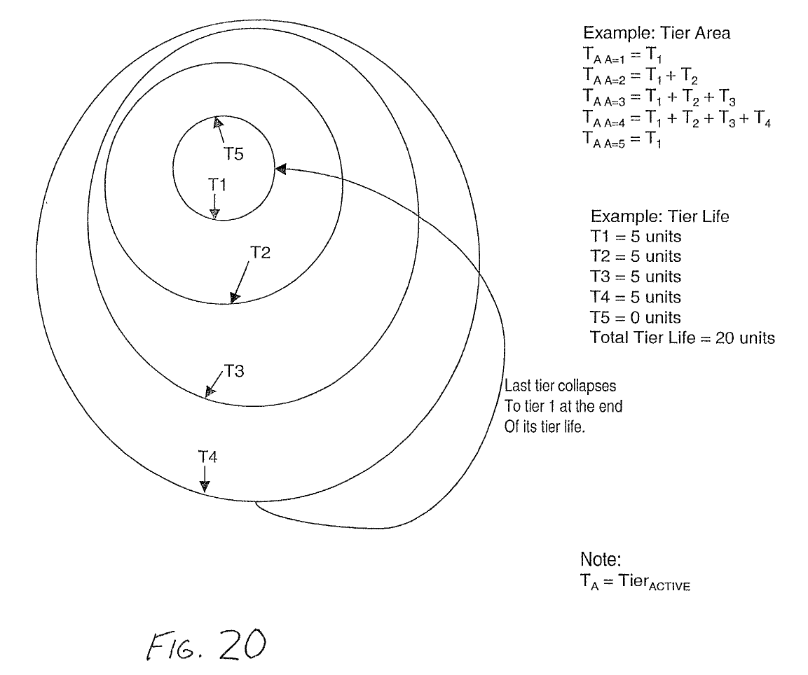

FIG. 20 illustrates a tier collapse model, indicating what happens when a bid request is sent to the outermost tier, but no bid is received. The tier collapse mode helps solve a common problem of Internet whopping. A consumer is often directed away from the local merchant when they use the World Wide Web portion of the Internet. When purchasing a product, the only option that they are often given is to purchase from some merchant in a distant city that the consumer has never heard of. This can create a situation where the consumer will terminate the purchase process because of his reluctance to give their credit card number to a stranger, concerns about delivery and concerns about returning the purchase if needed, among others. Through the use of a collapsing tiered network, the purchase is brought back to the local area when the search is unable to find a match with the consumer's requirements.

In FIG. 20, the tiering algorithm expands the active tier (TA) every five time units. Time units could be minutes, hours, days or any other generally recognized measurement of time. When the active tier expands to encompass a predetermined tier, shown in FIG. 20 as tier 4, it has grown to its maximum size. After tier 4 has served its expected life, the tiering structure collapses back to the original or home tier, and a D/A is selected from the home tier to fulfill the purchaser's request.

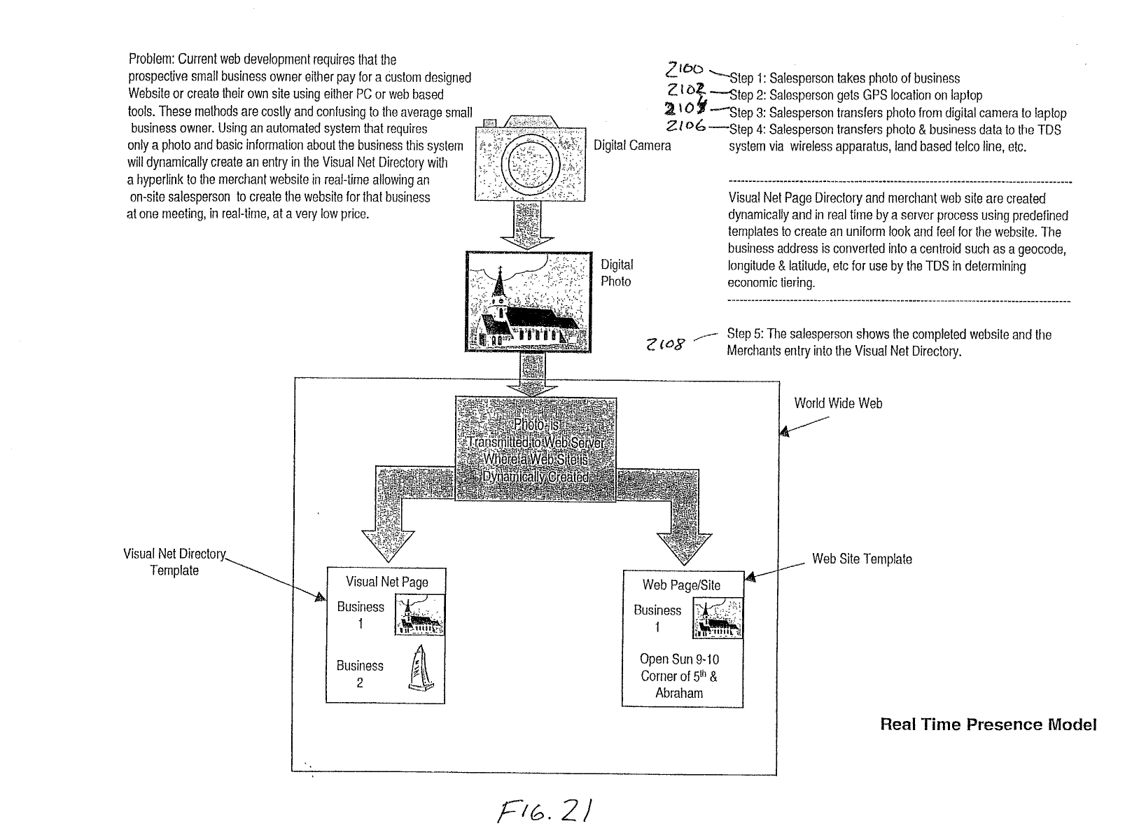

FIG. 21 depicts the process of creating a “live load.” The live load process is used to add participating merchants to the merchant database for inclusion in aspects of this invention operating with the TDS. Representative steps can include taking a digital photo of a business 2100, getting GPS location data for the business with a GPS receiver and a laptop or other portable device 2102, transferring the photo and other collected business data from the digital camera to the laptop or portable device 2104, and transferring the photo and business data to the TDS via a wireless apparatus, land based, telecommunications line, or other means known in the communications arts in order to create a Web site 2106. Finally, the completed Web site can be shown to the business. The business can receive a specific Web page and an entry in a visual net directory comprising that business as well as other businesses representing participating merchants. The net directory can be organized alphabetically by business name, or by topic or category into which each business belongs.

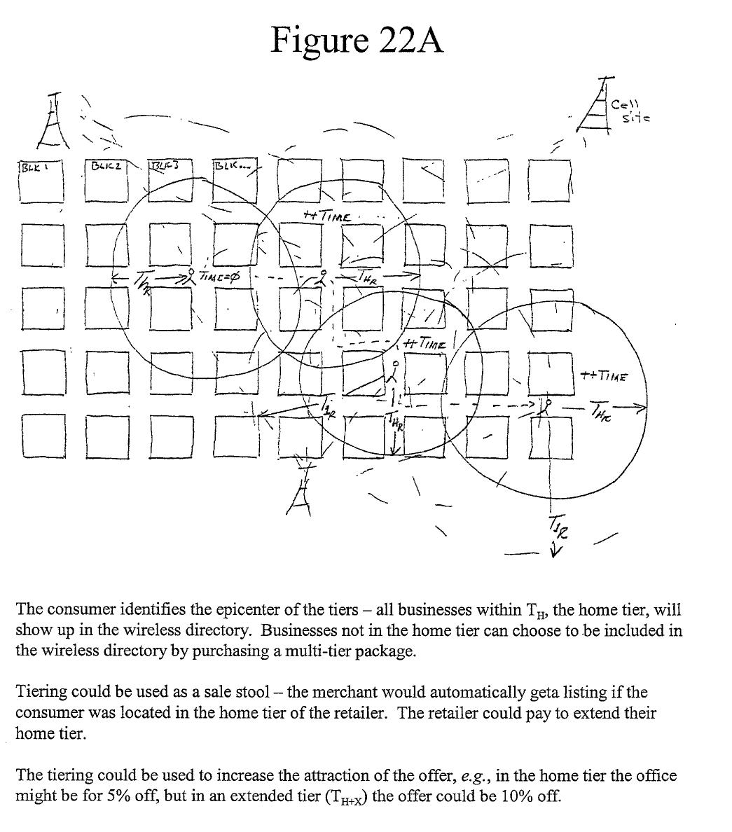

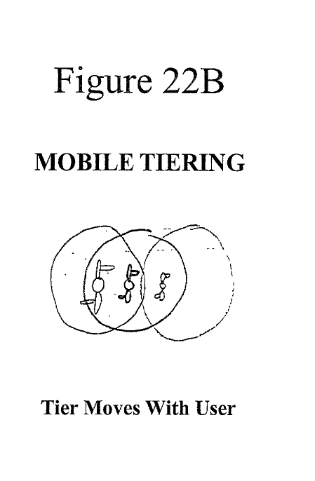

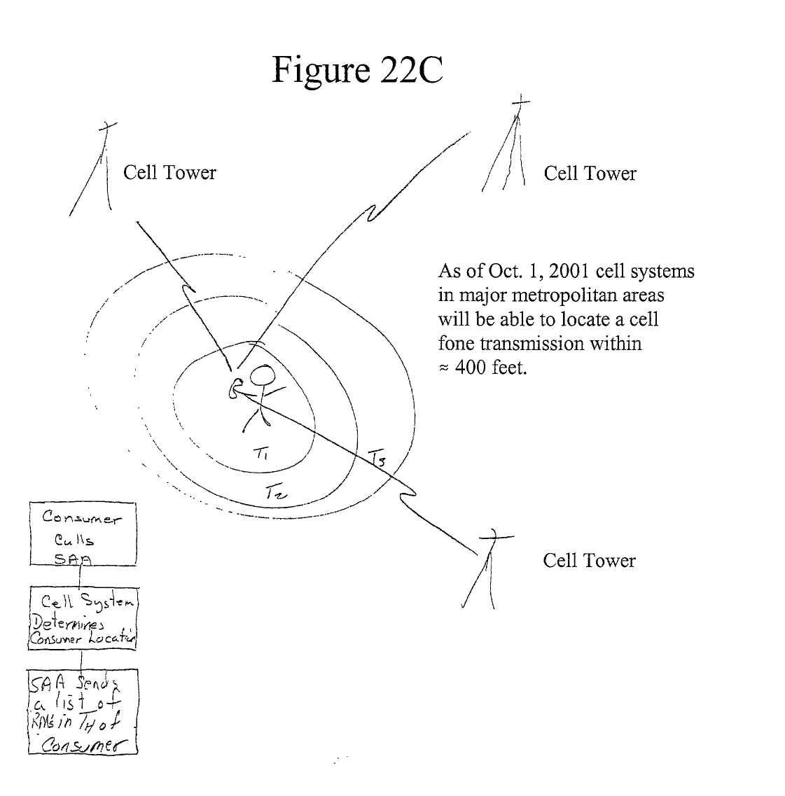

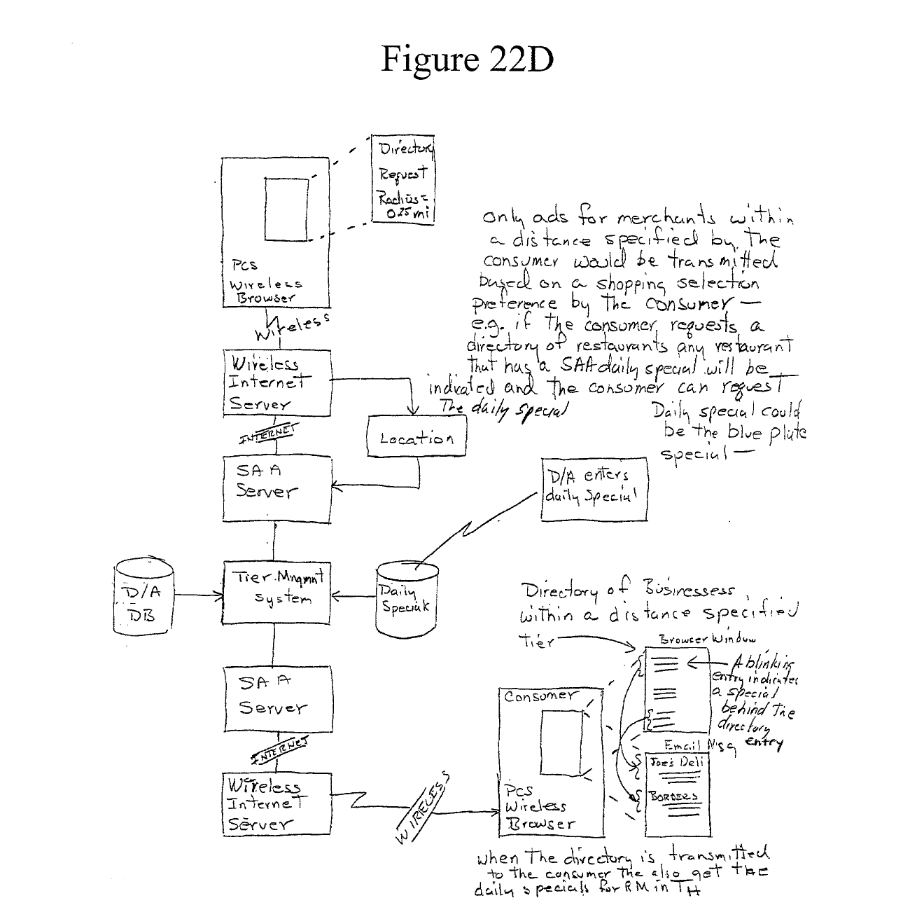

FIGS. 22A-22D illustrate the mobile tiering aspect of the present invention. As shown in FIG. 22A, the consumer represents the epicenter of the tiers, even though the epicenter itself can be moving. All identified businesses within the home tier, TH, will show up in the wireless directory. Businesses outside the home tier can optionally choose to be included in the wireless directory by purchasing a multi-tier package. Tiering could be used as a sales tool. The merchant can automatically get a listing if the consumer is located within a home tier of the retailer. The retailer can then pay to extend their home tier and include more consumers over a wider area. The tiering concept can be used to increase the attraction of the offer. For example, in the home tier, the offer might be for 5% off a catalog price, but for consumers in a more remote tier, TH+X, the offer might be for 10% off.

As illustrated in FIGS. 22B-22D, the epicenter of a tier can move with a consumer, such as is the case when a consumer is walking and using a mobile device to look for close businesses. Examples of mobile devices include cellular phones, laptop computers, palm top computers, PDAs, hand held computers, or other portable or wireless devices. Although the method of determining the location of the moving epicenter can vary, as known in the art of global positioning data technologies, four common examples can include the following. First, a GPS receiver can be used to squawk position data. Second, the location of the epicenter can be approximately triangulated based on signal strengths from surrounding telecommunication towers. Third, the mobile device can search for hand-offs of signals from one base station to another base station, and then use that information to approximate location. Fourth, a radio frequency fingerprint or mapping can be used to determine what RF signature or information should be received at each point in an area. The RF data actually received can then be compared to the mapping or fingerprint in order to determine location.

Finally, FIG. 22D depicts a flow process diagram for a wireless merchant mailer system similar to the merchant mailer system of FIG. 18. As shown in FIG. 22D, a method can be implemented whereby only ads for merchants within a distance specified by the consumer would be transmitted based on the shopping selection of the consumer. For example, if the consumer requests a directory of restaurants, any restaurant that has a daily special will be indicated and the consumer can request the daily special remotely. When the directory of businesses within a distance specified by the consumer, and corresponding to a tier, is transmitted to the consumer, the consumer also gets the daily specials in that tier. This way, the consumer can view each business and its specials.

It will be obvious to those having skill in the art that many changes may be made to the details of the above-described embodiments of this invention without departing from the underlying principles thereof. The scope of the present invention should, therefore, be determined only by the following claims.

1. A method for facilitating electronic commerce, the method comprising the steps of:
(a) at a first time, receiving from a mobile consumer at a first location a request to identify a merchant of a specified type within a specified distance from the mobile consumer;
(b) defining a boundary substantially centered about the first location and radially extending the specified distance from the first location in surrounding directions so as to encompass the mobile consumer; and
(c) identifying for the mobile consumer a merchant of the specified type within the defined boundary.

2. The method of claim 1, further comprising the steps of:
(d) at a subsequent time, identifying a next location of the mobile consumer; and
(e) in response to the next location differing from the first location, repeating steps (b) and (c) using the next location to define the boundary.

3. The method of claim 2 further comprising the step of periodically repeating steps (d) and (e).

4. The method of claim 1, further comprising the steps of, in response to there being no merchant of the specified type within the defined boundary:
increasing the specified distance by a predefined increment;
defining an expanded boundary using the increased distance; and
identifying for the mobile consumer a merchant of the specified type within the expanded boundary.

5. The method of claim 1 wherein said surrounding directions are defined in two dimensions.

6. The method of claim 1 wherein said surrounding directions are defined in three dimensions.

7. The method of claim 1 wherein the specified distance is measured in units of length.

8. The method of claim 7 wherein the units of length are miles.

9. The method of claim 1 wherein the specified distance is measured in units of city blocks.
